(19) United States
(12) Patent Application Publication
(10) Pub. No.: US 2023/0404110 A1
(43) Pub. Date: Dec. 21, 2023

(54) DIGESTIVE SUPPLEMENT TO MITIGATE ADVERSE REACTIONS

(71) Applicant: Hicare Health Foods Pty Limited, Queensland (AU)

(72) Inventors: David Tivey, Queensland (AU); Frank Van Doore, Queensland (AU)

(21) Appl. No.: 18/455,442

(22) Filed: Aug. 24, 2023

Related U.S. Application Data
(63) Continuation-in-part of application No. 17/089,025, filed on Nov. 4, 2020, now abandoned.
Application No. 17/089,025 is a continuation of application No. 15/310,667, filed on Nov. 11, 2016, now abandoned.

(30) Foreign Application Priority Data
May 9, 2014 (AU) 2014901724

(51) Int. Cl. A23K 50/40; A23L 33/10; A23K 10/16; A23K 20/174; A23K 20/163; A23K 20/28; A23L 33/21; A23L 33/15

(52) U.S. Cl. CPC A23K 50/40; A23L 33/10; A23K 10/16; A23K 20/174; A23V 2002/00; A23K 20/28; A23L 33/21; A23L 33/15; A23K 20/163

(57) ABSTRACT

A digestive supplement is disclosed that mitigates adverse reactions caused by food allergens. The digestive supplement also assists in the enhancement of digestive health of mono-gastric mammals. The mammals include but are not limited to companion animals and humans.

### CROSS REFERENCE TO RELATED APPLICATIONS

This application is a continuation in part of U.S. application Ser. No. 17/089,025, filed Nov. 4, 2020; which is a continuation of U.S. application Ser. No. 15/310,667, filed Nov. 11, 2016; which is a national stage application under 35 U.S.C. 371 and claims the benefit of PCT Application No. PCT/AU2015/050233 having an international filing date of May 11, 2015, which designates the United States, which claims priority to Australian Patent Application No. 2014901724, filed May 9, 2014, the entireties of these related applications being incorporated herein by reference.

### TECHNICAL FIELD

The invention relates to the field of commercial food manufacture. In particular, the invention relates to a digestive supplement of an inventive composition that is formulated to mitigate adverse reactions to specific allergenic components and dietary toxins in canines.

### BACKGROUND OF THE INVENTION

In the field of medical research, dogs have been used extensively for research. Specifically, dogs have shown to be a good model for human atopic diseases. “Numerous similarities exist between the human disease and the animal counterparts to the extent that animals could be used as models to improve our understanding of the pathogenesis of human Atopic Diseases”.

A review by J. Dressman (1986) identified that dogs can be used as effective models for gastrointestinal physiology and digestion in man.

Therefore, based on these studies and work done by other researchers in this field, preliminary data obtained from dog studies has direct application to the target species and can be reliably extrapolated to humans.

In the past ten years, the number of pets presenting at veterinary surgeries with food allergies has been rising. “It has been estimated that 20-75% of small animals seen in the average practice have skin problems as the main or concurrent complaint.

In 1998, a nationwide survey in Japan revealed that canine skin disorders were one of the most common reasons for visits to the veterinary clinic”.

Adverse food reactions can occur in up to eight percent of dogs, while up to 25 percent of all skin dermatoses can be attributed to adverse food reactions. However, only 10 to 15 percent of dogs will have concurrent intestinal symptoms. There does not appear to be a breed or sex predisposition, and onset can occur at any life stage.

Food allergy is probably the third most common hypersensitivity skin disease in dogs and cats after flea allergy and atopy.

The commercial petfood and veterinary industries has reacted to this problem with the development of specialist diets and medications. Whilst these developments have given some relief to pets and their owners, a more fundamental understanding of digestive processes, food allergy reactions, the impact of toxins and food borne bacteria was needed to enable a long term solution to be formulated.

Clinical signs of a food allergy can be variable, depending on the individual response, although the major clinical signs are itching and digestive problems. The diagnoses of food allergy can be difficult, as there is no single and completely reliable test available to help the clinician to confirm or refute the presence of food sensitivity. A diagnosis is usually based on dietary investigation in the form of elimination diets and test meals.

The allergic reaction can present itself in any manifestations. In companion animals, the major observable effects of an allergy are seen as frequent ear infections, poor coat quality, skin irritations and digestive issues. Skin irritations present as unsightly, possibly odorous, red patches on the skin. These irritations can cause the animal significant distress that may result in incessant scratching. Where a pet scratches excessively, it is not uncommon for the pet to scratch to the point of bleeding which is not only unpleasant for the owner and animal but may also lead to other complications such as skin infections and disease.

Digestive issues can result in a range of physical indicators, including low food consumption and problems such as loose bowel motions. Loose bowel motions are not only a problem for the pet but also for the owner as it can present a cleaning and hygiene issue. Initially the pet food industry responded to this problem with the inclusion of insoluble fibres and other ingredients that tended to bulk up faeces. While this was a good short term fix for the symptom, a greater and specific health agenda needed to be undertaken to solve the fundamental problem.

More recently the industry has responded with the development of elimination diets. These consist of foods which have ingredients that are chosen for having a low allergic reaction status. These diets can frequently contain unusual protein and carbohydrate sources which have a significant impact on the cost of the product to the owner. Elimination diets for dogs include lamb, chicken, rabbit, kangaroo, emu, horse meat and various species of fish as sources of protein, while rice of potatoes are the most popular carbohydrate sources.

The philosophy behind the use of the elimination diet is that it seeks to remove the allergen and avoid the adverse reaction and the subsequent sensitivity, such as a particular protein or the associated carbohydrate. Thus, by removing the suspected allergen and replacing it with novel proteins and carbohydrates, it is expected that the allergic reaction will subside. This approach, although successful in the short term, does not address the actual causes of the allergic reaction in the first place. The quote below demonstrates the difficulty in the use of elimination diets.

“Veterinarians used to regularly recommend lamb and rice for restrictive food trials because it was a food source not found in normal mixes. Lamb and rice were recommended for food allergy testing for so many years that the public got the impression that it was good for the skin. Companies started advertising their lamb and rice mixes as ‘recommended by dermatologists’. Currently the market offers a wide selection of lamb and rice based diet, most of which also contain corn, beef, chicken, and other components. These lamb and rice mixes do provide a complete diet, however, a lamb and rice diet are not inherently better than a normal diet. The popularity of the mixes has made them undesirable for restrictive diet trials unless owners know that their pet as never eaten a lamb and rice mix and unless there are no other protein or carbohydrate sources in the lamb and rice mix.”

Specialist low allergenic pet diets are expensive, costing up to ten times that of the normal commercial food products. While the elimination diet can be home prepared, it is usual for veterinary physicians to recommend one of the commercially available Low Allergy diets.

If the elimination diet route is unsuccessful, the second line of defence is steroid injections or immunotherapy to lessen the allergic impacts. While steroid injections and drugs can be successful, they may lose effectiveness in the long term and can have significant side effects. Steroid treatments are also expensive as the animal will require ongoing treatment. However, such methods are only addressing the symptoms and the not the cause of the adverse response to allergens.

Prior art (US Patent Application US2005/0119222 by the Proctor & Gamble Company) has dealt with additives to a companion animal's diet to alleviate these problems and improve digestive health. While this is valid for assisting the animal in improving lower gut processes and forming better stools, it does not treat the underlying allergic reaction which may be the cause of the problem.

Accordingly, it is an object of the invention to provide a dietary supplement for commercial pet food products that ameliorates at least some of the problems associated with the prior art.

### SUMMARY OF THE INVENTION

According to a first aspect of the invention, there is provided a food supplement product including inactivated whole cells of Saccharomyces cerevisiae and specific, high protein cell wall products, with a defined beta-glucan to mannan profile, from hydrolysis of Saccharomyces cerevisiae, selected dietary fibres and selected polysaccharides that support the growth of beneficial gut bacteria, and Montmorillonite clay. Preferably, the cell wall products include Mannans, Beta-glucans and B-group vitamins.

The Mannans and Beta-glucans are extracted (or derived) from the yeast cell wall using a specific process. The process yields a higher level of protein and selected polysaccharides at specific ratios. The polysaccharides support beneficial bacteria numbers and prevent pathogens binding to the lining of the digestive tract. The polysaccharides provide both a prebiotic and postbiotic effect on the dog's microbiome. Whilst other fragments of the cell wall are used in combination with the other ingredients in the patent mixture for binding pathogenic bacteria, assisting with modulating the immune response and helps protect the gastrointestinal tract.

The inventors determined that a food additive could be prepared by adding the components of yeast, including high protein (40% protein or above) cell wall fragments and Montmorillonite mineral clay. It was found that the addition of the clay enabled the blend to not only bind bacteria but also mycotoxins.

Montmorillonite clay is a very soft phyllosilicate group of minerals that typically form in microscopic crystals, forming a clay. It is named after Montmorillon in France. Montmorillonite, a member of the Smectite family, is a 2:1 clay, meaning that it has 2 tetrahedral sheets sandwiching a central octahedral sheet.

More preferably, the food or supplement further includes polysaccharides that support the growth of beneficial gut bacteria. The product according to the invention preferably also carries out several other functions. These functions include the creation of a suitable intestinal environment and management of the rate of progression of food through the gut, by modifying the viscosity of the food in the gut. Thus, prebiotic ingredients enable the creation of a suitable gut environment. Advantageously, said polysaccharides include at least one material selected from the group consisting of: inulin; glucose oligosaccharides derived from corn-starch; Psyllium fibre; xanthan gum; and Maltodextrin.

The food or supplement composition may then be yet further enhanced through the use of other ingredients, most advantageously: soluble and insoluble fibres and vegetable starches, glucose, dicalcium phosphate and vitamin C. These ingredients carry out several functions such as slowing progress of food through the gut and providing essential nutrients for the healthy bacterial environment to be established more efficiently. These additional ingredients interact with the whole yeast and high protein yeast fragments to create the prebiotic environment.

Preferably, the food composition is characterised by a dry mass ratio of yeast and yeast products to Montmorillonite clay in the range 10:1 to 3:1; and a dry mass ratio of yeast and high protein (greater than 40% protein) yeast products to prebiotic materials in the range 20:1 to 4:1. Where the food product is for feeding to canines, the preferred ratio of yeast and yeast products to Montmorillonite clay is in the range 6:1 to 4:1.

Laboratory and in-home placement tests of a food supplement has shown that the novel combination of these ingredients in the ratios provided have a synergistic effect.

According to another aspect of the invention, there is provided a pet food additive for modifying the rate of progression of food products through the gut of a canine, said pet food additive comprising: cell wall fragments from lysed or partially lysed cells of Saccharomyces cerevisiae, wherein the cell wall food products include Mannans, Beta-glucans and B-group vitamins; Montmorillonite clay, prebiotic material selected from the group consisting of: inulin; glucose oligosaccharides derived from corn-starch; psyllium fibre; xanthan gum and maltodextrins soluble fibres; insoluble fibres, vegetable starches, glucose, di-calcium phosphate and Vitamin C; and wherein the mass ratio of fragments from lysed or partially lysed cells of Saccharomyces cerevisiae to Montmorillonite clay is in the range of 6:1 to 4:1; and wherein a dry mass ratio of said fragments from lysed or partially lysed cells of Saccharomyces cerevisiae to prebiotic materials is in the range of 20:1 to 4:1.

Preferably said cell wall fragments have a protein content of 40% or greater, and said Saccharomyces cerevisiae culture was grown under aerobic conditions.

According to another aspect of the invention, there is provided a method of modifying the rate of progression of food products through the gut of a canine, said method comprising the step of administering to said canine a pet food additive according to that described above.

According to another aspect of the invention, there is provided a method of modifying the viscosity of food products as they pass through the gut of a canine, including the step of administering to said canine a pet food additive according to that described above.

According to another aspect of the invention, there is provided a method of mitigating adverse reactions to allergenic components, dietary toxins and foodborne pathogenic bacteria in a canine, including the step of administering to said canine a pet food additive according to that described above.

Further advantages of a food product according to the invention include:

1. That the key ingredients disclosed above act synergistically to lessen the allergic response by reducing the production of pro-inflammatory cytokine by epithelial cells (e.g., cells that constitute the lining of the digestive tract) in response to allergen binding. This helps to maintain epithelial barrier function and reduces the risk of ‘leaky gut’ as well as loss of electrolytes.

2. That the food composition enhances cell-mediated immunity through the activation of macrophages.

3. That the food composition also provides essential nutrients for intestinal repair as high protein lysed cells of Saccharomyces cerevisiae is a source of nucleotides that have been shown to promote repair of gut tissue after an inflammatory damage e.g., weaning or villus atrophy in response to dietary antigens.

4. That the food composition provides protection against the attack of specific pathogens groups through its ability to reduce the capacity of the pathogen to bind to the intestinal lining. To do this, the composition has specific ingredients that act as decoy molecules that bind to potential pathogenic bacteria, e.g., E. coli. This helps to prevent colonisation of the digestive tract.

5. That the food composition provides specific digestive fibres to support and enhance digestive function through correct supplementation. The specific digestive fibres contain oligosaccharides of varying length that provide proven fibre effects along the entire large bowel.

6. That the food composition also provides novel prebiotic nutrition through the addition of yeast cell wall fragments, inulin, glucose oligosaccharides, vitamin C and glucose, all of which stimulate and enhance the growth of beneficial bacteria in the gut.

7. That the food composition also creates the environment in the large bowel that causes the modification to protein digestion. The fibre and prebiotic actions promote the incorporation of amino acids into bacterial protein. This reduces protein fermentation by-products in the faeces, resulting in less malodours and improved faeces formation, which is important for indoor animals such as canines.

Now will be described, by way of a specific, non-limiting example, a preferred embodiment of the invention.

### BRIEF DESCRIPTION OF THE DRAWINGS

FIG. 1 is a schematic diagram illustrating components of an intestinal barrier;

FIG. 2 is a schematic diagram illustrating an impact of a compromised intestinal barrier;

FIG. 3 is a schematic diagram illustrating classification of adverse food reactions in mammals and the impact of the invention to ameliorate;

FIG. 4 is a photograph showing the slurry containing DIG according to recipe 1;

FIG. 5 is a photograph showing the slurry containing DIG according to recipe 2;

FIGS. 6 and 7 show the differences between the viscosity for the range of pH's tested for the PF2 slurry with and without the DIG supplement;

FIG. 8 is a Graph of Viscosity vs RPM for Recipes #1 (DIG) @ pH2.2 and #2 (Std PF2) @ pH 2.38;

FIG. 9 is a Log-Log Graph of Viscosity vs RPM for Recipes #1 (DIG) @ pH2.2 and #2 (Std PF2) @ pH 2.38;

FIG. 10 is a graph of Viscosity vs RPM for Recipes #1 (DIG) @ pH3.10 and #2 (Std PF2) @ pH 3.25;

FIG. 11 is a Log-Log Graph of Viscosity vs RPM for Recipes #1 (DIG) @ pH3.10 and #2 (Std PF2) @ pH 3.25;

FIG. 12 is a Graph of Viscosity vs RPM for Recipes #1 (DIG) @ pH3.98 and #2 (Std PF2) @ pH 4.03;

FIG. 13 is a Log-Log Graph of Viscosity vs RPM for Recipes #1 (DIG) @ pH3.98 and #2 (Std PF2) @ pH 4.03;

FIG. 14 is a graph of Viscosity vs RPM for Recipes #1 (DIG) @ pH5.30 and #2 (Std PF2) @ pH 5.37;

FIG. 15 is a log-Log Graph of Viscosity vs RPM for Recipes #1 (DIG) @ pH5.30 and #2 (Std PF2) @ pH 5.37;

FIG. 16 is a graph of Viscosity vs RPM for Recipes #1 (DIG) @ pH6.50 and #2 (Std PF2) @ pH 6.56;

FIG. 17 is a Log-Log Graph of Viscosity vs RPM for Recipes #1 (DIG) @ pH6.50 and #2 (Std PF2) @ pH 6.56;

FIG. 18 is a graph of Viscosity vs RPM for Recipes #1 (DIG) @ pH7.58 and #2 (Std PF2) @ pH 7.55; and

FIG. 19 is a Log-Log Graph of Viscosity vs RPM for Recipes #1 (DIG) @ pH7.58 and #2 (Std PF2) @ pH 7.55;

FIG. 20 shows the range of fibres used in the inventive product and their impact on the digestive process;

FIG. 21 shows microbial composition before and after supplementation with A or B (post) compared with a standard diet (initial);

FIG. 22 is a graph showing microbial compositions;

FIG. 23 is another graph showing microbial compositions;

FIG. 24 is another graph showing microbial compositions;

FIG. 25 is another graph that shows the diversity of Firmicutes at the order level pre- and post-treatment with the inventive supplement;

FIG. 26 is another graph showing the diversity of proteobacteria at the order level for each dog pre- and post-treatment with the inventive supplement;

FIG. 27 is another graph showing the diversity of proteobacteria at the order level pre- and post-treatment with the inventive supplement;

FIG. 28 is another graph that shows the diversity of selected species in each dog pre- and post-treatment with the inventive supplement; and

FIG. 29 shows the diversity of selected species pre- and post-treatment with the inventive product of the invention.

### DETAILED DESCRIPTION OF THE INVENTION

The digestion process is one of the most complex multiphase and multicomponent operations that any animal undertakes on a daily basis. Its function is to extract the essential nutrients and energy needed for an individual to survive that day and to ensure the excretion of waste products.

In higher mammals, digestion and absorption is a highly evolved process with many stages and specific bodily secretions needed to ensure that the digestion, absorption and elimination processes happen at the appropriate stage during the food passage through the gut.

It has been known for many years that beneficial bacteria reside in the gut in what is, essentially, a symbiotic relationship with the mammalian host. The roles and functions of these bacteria is becoming better understood as research has focused more resources on the type and function of each species found in different parts of the digestive tract.

As described above, the mode of action of the food composition according to the invention is one that positively modifies the environment of the gut to improve digestion of food as well as enhancing the body's overall immune status. This is a simplification of the actual process that is occurring within the digestive system. A more technical description would be that the inventive composition is responsible for the ‘bioengineering’ of the intestinal environment, especially the components that constitute the intestinal barrier, although the precise mode of action to affect such changes has not been described.

The intestinal or epithelial barrier is the boundary between the outside world and the body's inner working. When functioning correctly, it keeps the deleterious material out, allows waste products to be removed, and importantly, it allows essential nutrients into the body. Maintenance of this barrier is very important and energy consuming. Anything that damages the system would clearly increase the requirement for energy and nutrients just to maintain this barrier.

Optimisation of the barrier not only protects the individual from disease but also from the inappropriate presentation of potential allergens to the immune system and helps the body to maintain a hydrated state. Without a well-functioning intestinal barrier, the individual is at risk of becoming unwell.

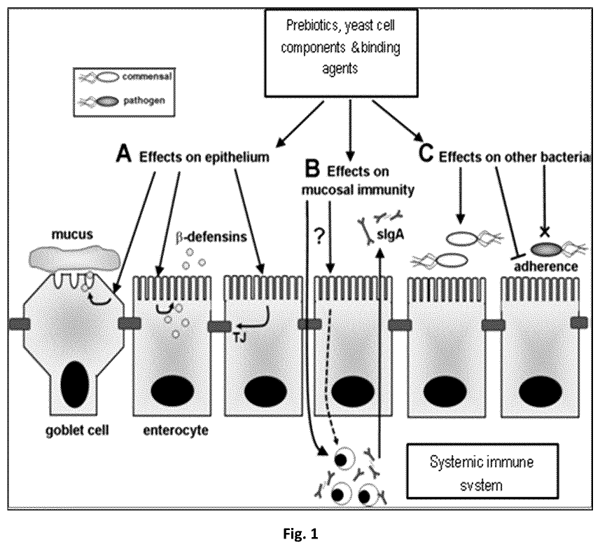

The components of the intestinal barrier are detailed in FIG. 1. Essentially, the barrier consists of; the epithelial cells that line the intestinal tract, the mucus that overlays these cells, bacteria that are either in the lumen or embedded in the mucus layer, specialised antigen sampling cells in the Peyer's patches and the immune system associated with the intestinal tissue. Clearly, the system is complex and multifactorial; in addition, moving along the length of the gut the relative proportions of the barrier components change. FIG. 1 also illustrated the tight communication between the immune system of the gut and the body (systemic).

The complex nature of the barrier requires that any product designed to support it must be multifunctional in nature. This may be achieved by a single compound that has more than one action. However, the inventors have determined that a multi-component blend formulated through the careful selection of a range of ingredients that target individual components of the barrier is required for consistent and reliable results. The food composition according to the invention has been designed according to the later premise. The ingredients used in the composition appear to act in a greater than additive, or synergic manner.

The food composition according to the invention has been designed to safeguard against multiple challenges to the integrity of the intestinal barrier, thereby helping to promote both good gut health as well as overall well-being. One of the key advantages of the inventive composition is that it achieves these functions with a single product that is easy to use and highly palatable.

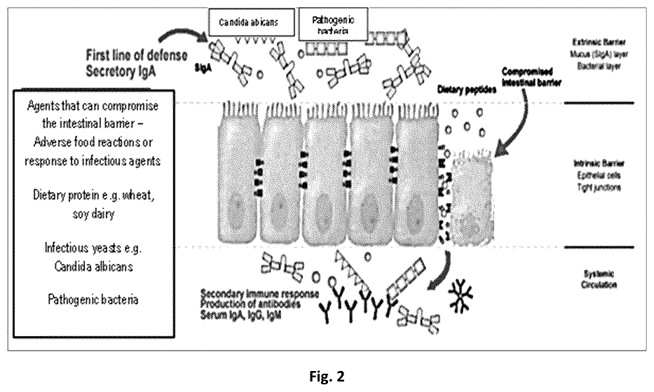

The appropriate first line of antibody defence against potentially harmful agents is the antibody: secretory IgA. This binds to the offending threat, e.g., E. coli or dietary antigen, and aids in the elimination or neutralisation of the threat. FIG. 2 illustrates the impact of a compromised intestinal barrier, which results in the transfer of partial breakdown products from protein (dietary peptides) passing freely through the spaces between adjacent intestinal cells. The net result is presentation of such peptide to the immune system resulting in a potentially adverse immune reaction.

On the next presentation, the dietary peptide or protein is recognised by the immune system with the initiation of an immune reaction. This tends to result in an inflammation and damage of the intestinal tract. The consequence of which can include dysfunction of the digestive tract (e.g., diarrhea or cramps) and/or skin irritations. Under certain circumstances this can result in a life threatening hypersensitivity.

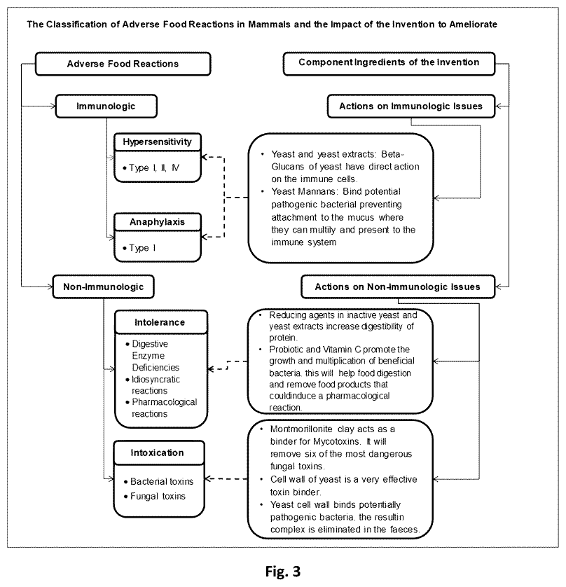

The consequence of a breakdown in barrier function, shown in FIG. 2, is an Adverse Food Reaction (AFR). AFRs are classified by type in FIG. 3. The figure also details the components of the composition that target this type of AFR.

AFRs tend to have multiple aetiologies, as shown in FIG. 3. Most of the immune responses result in marked clinical symptoms that, once diagnosed, are effectively treated by avoidance of the antigenic agent. However, adequate intestinal barrier function may provide a prophylaxis, in that an intact intestinal barrier would prevent presentation of antigen and hence the subsequent development of hypersensitivity, thereby providing a protection against the accidental consumption of the offending food antigen.

More common are the intolerances, intoxications or infections of the digestive tract. Most will result in the individual being ‘off colour’ with no defining diagnostics. The components in the inventive composition can directly combat the cause of such AFRs and as such protect the individual from accidental consumption of bad or mouldy foods or ingestion of pathogenic bacteria. These functions are also enhanced by promoting beneficial bacteria through the prebiotic components in the composition.

The inventive composition is a formulation of various foods and ingredients in single supplement or food that act in combination to mitigate adverse reactions by (1) tightening the intestinal barrier to reduce the presentation of allergens to the immune system (2) assist the immune system to respond appropriately to any challenge (3) bind ingested toxins rendering them inert and (4) promote the individual's beneficial bacteria to improve digestion, intestinal barrier function and outcompete harmful bacteria.

In a preferred embodiment, the inventive composition for different mammal species is comprised as set out in Table 1.

TABLE 1

| | Percentage ranges |
|---|---|
| Ingredient | (Dry mass %) |
| Yeast and Yeast products (including inactivated | 30 to 80% |
| whole cells and cell | |
| wall fragments from Saccharomyces cerevisiae) | |
| Vegetable flour (Potato and/or Carrot) | 5 to 20% |
| Fibre (Psyllium or Xanthan and/or Inulin | 3 to 12% |
| and/or maltodextrin) | |
| Montmorillonite mineral clay | 3 to 15% |
| Glucose | 0.5 to 15% |
| Di-calcium Phosphate | 0.1 to 5% |
| Natural Flavours | 0.1 to 2% |
| Vitamin C | 0.5 to 3% |

The variation in the percentage ranges of the ingredients in Table 1 is to accommodate the differing requirements for different mammal species.

Variations are also required to allow for mammals at different life stages and species. For example, a puppy will have different digestive needs and allergic responses to that of an adult dog. Similarly, an adult animal in the prime-of-life will have differing issues to a geriatric animal. Differing breeds have also been shown to have varying responses and sensitivities to food allergens. Therefore, the optimal composition will vary depending on the species, breed and life stage of the target animal, a general approach well understood in the art.

Initial investigations into the application of the specific high protein yeast fragments (from Saccharomyces cerevisiae) showed that a reduction in the allergic reaction could be effected through the use of this ingredient alone. However, this approach was limited in its ability to stabilize the environment of the digestive tract and limited capacity to absorb mycotoxins and assist with the repair of the gut lining. It was then decided to investigate other elements that can assist to engineer the gut environment and provide protection again mycotoxins.

The yeast material used in the composition according to the invention is a co-product derived from a process used to deliver a high value, yeast based, flavour concentrate. The flavour concentrate is used by the human food industry.

The co-product remaining after the flavour is extracted contains a unique yeast cell wall extract. This extract is a combination of cell wall material, cell nuclear material and whole lysed cells.

The yeast is grown under aerobic conditions to prevent the formation of alcohol during fermentation. After fermentation is complete, the yeast is autolysed and separated from the bulk of the cellular nuclear material. The cellular nuclear material is concentrated and used for human food use.

As a result of the great care that is used during the process to ensure that the correct flavour is obtained, the remaining co-product is similarly made up of a highly consistent and specific cell wall extract that is made up of yeast cell wall fragments and remaining nuclear material.

The inventor's initial investigation into the yeast types used on other patents or currently in the marketplace showed that, for petfood, the focus was on the use of spent brewers' yeast or spent brewers' grain.

During the production of beer, yeast ferments the simple sugars present in the cooled wort to alcohol. In brewing, yeasts are generally classified into two broad categories: Top-fermenting ‘ale’ yeasts which consist of Saccharomyces cerevisiae strains and bottom-fermenting ‘lager’ yeasts of Saccharomyces pastorianus and Saccharomyces carlsbergensis strains.

Thus, the term ‘brewers’ yeast’ denotes an array of different yeast types used in the manufacture of different alcoholic beverages. The species used will vary depending on the type of beer, lager or wine produced and is rarely a single species. The fermentation process is carried out under anaerobic conditions to maximise the production of alcohol.

The method of preparation of the yeast for inclusion in the inventive additive is as follows:

Step 1: Raw Materials Preparation

Supplier holds pure cultures of the Saccharomyces cerevisiae yeast—these are maintained by growth on nutrient slopes, harvested and maintained frozen until needed for production.

Molasses: molasses provides the necessary energy source for yeast growth. Molasses is first sterilised with steam before passing through clarifiers. Molasses is stored under sterile conditions in stainless steel tanks.

Step 2: Production of Seed Culture

The pure culture of baker's yeast is inoculated into a seed fermenter which contains sterile molasses and other essential nutrients. After reaching desired cell density, the seed culture is transferred to the main fermenter tank.

Step 3: Fermentation

Once in the main fermenter the seed yeast is feed molasses and essential nutrients as necessary to maintain growth pattern. In addition, high volumes of sterile air are pumped through the culture medium to ensure necessary oxygen level to support rapid growth while avoiding anaerobic fermentation and ethanol production.

Step 4: Separation

On completion of the fermentation process, the yeast cell is separated from the culture medium. The yeast cream is produced through separation by centrifugation and water washes. The final product is a suspension of Saccharomyces cerevisiae yeast cells. This product is known as the yeast cream and stored cold.

Step 5: Autolysis:

Cream yeast is treated with temperature, Ethyl Acetate, salt, and papain to initiate the autolysis process. Cold yeast cream is warmed to 38° C.—heat increment 9.5° C./hour. At 38° C., Ethyl Acetate, salt, and papain is added to the mix. Yeast cream further heat to 48° C. Typical time to reach 48° C. is 6 hours. Mix is then kept at 48° C. for 22 hours. Then the yeast cream temperature is raised to 54° C. and held for 4 hours prior to separation and evaporation.

Step 6: Separation of Yeast Cell Walls:

The autolysed yeast cream is separated into two liquid fractions via centrifugation: Yeast Autolysate (YA) and Yeast Cell Wall (YCW) extract. The YCW extract is undergoes a second separation to ensure near complete recovery of YA.

Step 7: Extract Evaporation:

The YA is circulated through an evaporator until the desired solid density is reached. The YCW is passed through a plate heat exchange to pre-heat before flash drying on a roller drum.

TABLE 2
Differences in macromolecular composition of cell wall
material between typical spent brewers' yeast and the
yeast cell wall extract used in the Invention.

| | Variation in | Yeast cell wall |
|---|---|---|
| | typical Spent | extract used in |
| | Brewers' Yeast | examples |
| | Content | Content |
| Macromolecule | (% DM) | (% DM)* |
| Mannan-oligosaccharides | 25-70% | 14% |
| 1.3-1.6 β-Glucans | 30-60% | 15% |
| Protein | 20 to 35% | 48% |

As a result of the differences in yeast species, raw materials, processing, and the final recovery of the cell wall material, the inventors believe that there is no parallel between inventions and existing products in the marketplace that use spent brewers' yeast and the yeast cell wall extract that is used in the additive according to the invention.

Further research showed a blend could be prepared by adding the high protein Yeast cell wall fragments (principally: Mannans, Beta-glucans and B-group vitamins) and a specific Montmorillonite mineral clay. It was found that the addition of the clay enabled the blend to not only bind bacteria but also mycotoxins.

However, to be optimally effective, the inventive composition has been designed to carry out several other functions. These functions include the need to create a suitable intestinal environment and manage the rate of progression of food through the gut. Thus, prebiotic ingredients (inulin and glucose oligosaccharides derived from corn-starch) were sought to enable the creation of a suitable environment. The blend was then further enhanced through the use of soluble and insoluble fibres and vegetable starches, glucose, di-calcium phosphate and vitamin C.

These ingredients were selected to carry out several functions such as controlling the progression of food through the gut and providing essential nutrients for the healthy bacterial environment to be established more efficiently. These additional ingredients are thought to interact with the whole inactivated yeast and high protein yeast fragments to create the prebiotic environment.

Table 1 above shows the approximate amounts of each of the individual components of the inventive food composition. If the amounts of each of the individual ingredients were consumed alone, it is anticipated that they would only have a limited impact on the animal. However, laboratory and in-home placement tests have shown that the combination of these ingredients in the ratios provided, have an apparent synergistic effect.

The use of natural flavours and gels also aid in flavour and texture development, respectively.

The inventive technology uses a range of soluble and insoluble fibres and resistant starches to act as food sources for differing species of beneficial bacteria along the digestive path. The fibres also perform a secondary function by helping to control the viscosity of the luminal contents. The synergistic effect of the fibres in slowing the progress of food material through the gut enables the growth of beneficial bacteria while helping the animal to absorb more nutrients and helping to form a more solid stool.

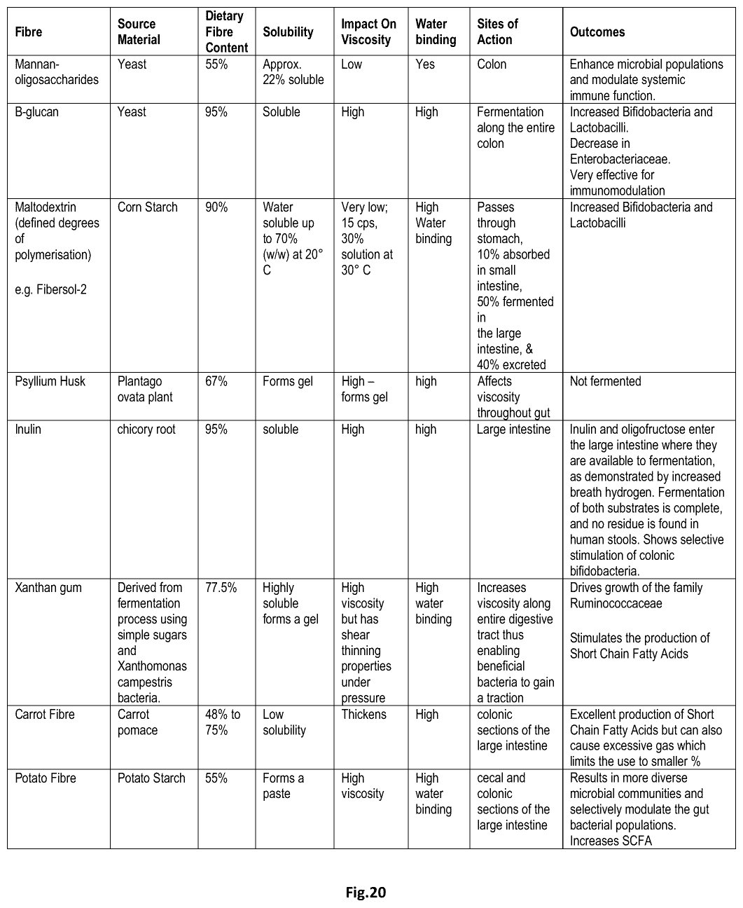

FIG. 20 shows the range of fibres used in the inventive product and their impact on the digestive process. The use of different fibres shown in Table 2, shows that the key target is in the growth of beneficial bacterial along the entire length of the digestive tract. This is achieved by: helping to control the viscosity of the luminal contents, thus slowing the progress and allowing bacteria extended time to access the nutrients: acting as an absorbent to remove toxins and harmful bacteria; and acting as a food source to different bacterial groups which inhabit different segments along the alimentary canal.

The levels of different fibres are controlled to ensure that there is little likelihood of gut impaction or hard stools from an excessive amount of fibrous material in the gut. The selection of several different fibres and adding these at low levels helps to reduce the risk of odours gases forming in the lower colon which will cause the pets owner a high degree of nasal discomfort when the gas escapes.

### Example 1: Evaluation of Invention Using In-Home Survey

After extensive laboratory testing, it was decided to utilize a dog model to test the composition effectiveness by using a pet dog population in an in-home evaluation. The study was undertaken to understand customer and consumer perception of the technology and its outcomes. The product was presented as a food supplement.

A test recipe, as shown in Table 3, was derived using the base formulation shown in Table 1.

TABLE 3
Test Recipe

| | Percentage |
|---|---|
| Ingredient | (dry basis) |
| Yeast and Yeast products (including inactivated whole | 51% |
| cells and specific high protein cell wall fragments | |
| from Saccharomyces cerevisiae) | |
| Vegetable flour | 14% |
| Fibre (Psyllium and/or Xanthan and/or Inulin and/or | 5% |
| maltodextrin) | |
| Montmorillonite mineral clay | 15% |
| Glucose | 12% |
| Di-calcium Phosphate | 1% |
| Natural Flavours | 1% |
| Vitamin C | 1% |

The pool of participants was sourced from the customer list of a local pet products supply companies and special interest groups relating to specific dog breeds. The prospective participants were first asked to fill out a preliminary survey questionnaire which included questions relating to the dog's breed, age, size, current diet and general health status.

The initial survey information was reviewed, and twenty-one dogs were selected to enter the trial. The review endeavored to ensure that a representative cross-section of the pet population was present in the trial. While some pets with severe health issues were excluded, it was decided to allow 33% of the test subjects to have pre-existing, but not life-threatening, veterinary issues to participate in the trial. Earlier research indicated that the specific health issues that these animals had may benefit through the use of the test recipe to their diet. The test panel ran for thirty days.

All animals participating in the trial were considered adult pets with an average age of 6.54 years (age range from 1.5 to 16.6 years, SD±4.5) and an average weight of 23.3 kg (weight range from 3.6 to 56 kg, SD±14.6).

The participants were instructed to include the test recipe into their dog's existing diet either by direct addition of the powder or by mixing the powder with a small amount of water and pouring over the meal.

While the use of home placement testing is the most appropriate in determining if a product is effective in a real world situation, it often poses difficulties in gathering meaningful data. As most pet owners are not trained in clinical veterinary practices, signs such as skin discolouration and other such allergic type indicators may be misinterpreted by the untrained eye and the results obtained could be misleading. However, one sign that pet owners are very familiar with is the quality of their pet's bowel motions.

Cleaning up and disposing of pet waste is one of the least enjoyable duties of pet ownership. When a pet's stool is loose or diarrheal, it presents a particularly unpleasant task, and can pose a significant health risk to the person cleaning it up.

Therefore, to judge the impact of the test recipe on digestive health, the participants were asked to judge the quality of their pet's stool using the internationally recognised Waltham Faeces Scoring System.

The Waltham Faeces Scoring System uses a 5-point scale. A stool with a score of 1 is a solid mass of hard faeces that may be difficult for the animal to pass, while a score of 5 is unformed, watery and diarrheal. A low score of 1 or a high score of 5 will usually indicate gastrointestinal distress or disorder. The preferred target score is between 2.0 to 3.0.

The participants were asked to fill out an online survey pre-trial, on the seventh day, and again after the trial had concluded at the thirty-day mark.

The participants were asked to rate their pet's stools before the trial, at the seventh day mark and after the trial period (30 days). The results are summarised in table 4 below.

TABLE 4
Results of In-Home Placement Trial

| | Day 0 (Pre-Trial) | Day 7 | Day 30 |
|---|---|---|---|
| Unacceptable Stools | 14 | 8 | 5 |
| (Waltham Scores less than 2 | | | |
| and greater than 3) | | | |
| Acceptable Stools | 7 | 12 | 15 |
| (Waltham Score 2 to 3) | | | |
| % Acceptable Stools | 33% | 60% | 75% |

Notes
One dog was withdrawn of the survey after the first week at the owner's request.
Panel = 20 dogs

The trials showed a significant improvement in the quality of the pet's stools. The change in stool quality resulting from the use of the test recipe also had a positive impact on the attitude of the pet owners, as it made the daily clean-up easier. Many owners reported that their pet's activity levels, coat and general demeanor improved during the trial. This gave the owners a sense of wellbeing as they felt that they had helped to improve their pet's health. The survey asked the participants to provide comments on their impressions of the use of the test recipe and the impact on their pet. The participants' responses are given as follows:
“A lot easier to clean up. Shelby would often have severe bouts of diarrhoea 5 and 4.5 but since using the Additive, the worst I have had is a very little of 4.”
“I think they have definitely improved heaps.”
“It has improved plus it seems to be less.”
“Hannibal's stools are firm in texture. He only goes once a day for a stool motion.”
“Very easy to pick up. Great advantage for me . . . the picker upper.”
“Most times the poos are a 2 to a 2.5. Sometimes it can be a 4 but not often.”
“He had been suffering from all sorts of stools before he had the Additive and kibble, even with just the Additive, his stools were a mixture of wet and very sloppy, but when mixed with the kibble, Morgan's stools were almost perfect, and that's pretty good considering he is on and off all sorts of different medication.”
“Not watery any more but still could be firmer . . . . No more poop in the house which is very nice!”
“Better formed and less runny.”

It was concluded that the use of the test recipe, according to the invention, in a pet's diet produced a significant improvement in pet health. The changes were significant and observable to the pet owners.

### Example 2— Effect on Viscosity of Digesta

The digestive process is one of the most challenging actions performed by a companion animal to ensure its survival. The digestion of food material begins with mastication of the portion to diminish its size. Through the combination of the cutting/grinding action of the jaws and the addition of enzymes and lubrication from the salivary gland, the consistency of the food is rendered suitable for passing down the oesophagus into the stomach.

Food particles are reduced further in the stomach by peristatic action and the addition of acids and enzymes, allowing digestive processes to commence. The average gastric pH of dogs' ranges from pH1.5 to pH2.1 units. A major part of the digestion occurs after passing through the duodenum and into the small intestine, followed by the transverse colon and descending colon. The pH range of the major part of the digestive process exists between 5.5 to 7.5 units. At the rectum, any remaining undigested materials are excreted from the body.

At every step of this process, the consistency and viscosity of the digesta are critical to the efficient uptake of nutrients, recovery/release of water and the consistency of the final stool.

During the development work on the invention, the inventors recognised that the stools of dogs with gut health problems displayed as either hard and lumpy, or loose and watery. Both types of stools indicate a lack of consistency during the digestion process, stemming from various issues such as a reaction to food allergens, the presence of toxins or localised infections by pathogenic bacteria on the gut lining.

The invention required further testing to see if potential customers would recognise the change in their dog's gut performance and stool quality.

In-home placement trials were conducted using a panel of 21 household dogs. The trials were carried out to assess the effectiveness of the inventive formulation in a real-world environment. Owners were asked to mix the inventive formulation into their dog's daily meals and report back.

At the 7-day and 30-day marks of the trial, their findings and comments were collected using online polling software. Owners were asked to report on various animal responses and features, such as palatability and acceptance of the supplement. Owners were also asked to rate the quality of the dog's stool using the internationally recognised Waltham Stool Scale.

The Waltham Stool Score is a 5-point scale, with 1 representing a hard, difficult-to-pass stool and 5 indicating a diarrheal stool. A healthy animal should have a stool score of 2.5 to 3.5.

In summary, the results show the following trend:
Pre-Trial: 7/21 (33%) dogs had acceptable stools
After 7 Day of using the additive, online Survey results: 12/20 (60%) dogs had acceptable stools (one dog was withdrawn by the owner.)
Post-Trial at 30 days of using the additive, online survey results: 15/19 (79%) dogs had acceptable stools (A further dog was withdrawn due to physical injury unrelated to the trial)
At the end of the trial, owners reported that stools were firmer and had a more consistent texture. These features were seen as very important by the owners as the stool improvements allow for easier recovery and disposal.

A later, more generalised follow-up survey showed that long-time users were very happy with the continued effect of firming up the stool. Several also commented that the inventive supplement significantly reduced the flatulence odour being emitted by their dogs. Owners also noted that if they missed giving their dog the supplement for 5 to 7 days, the unpleasant flatulence odour returned, and stool quality diminished.

The design of the inventive supplement formulation technology took into consideration the following digestive issues:
the requirement to reduce the impact of food allergies.
the need to absorb mycotoxins and pathogenic bacteria.
provide prebiotic support for the growth of beneficial bacteria.
to control the flow of the food materials at each step of the digestive process to enable the development of an effective microbiome, enable optimum nutrient absorption and to maximise the effect of the other components of the Inventive formulation.

The bench work below aimed to establish a quantifiable effect on the viscosity of the digesta during the digestion process. The specific aims were:
Developing a suitable system using ground dry dog food combined with water to form a slurry in roughly the same ratios as a dog would consume on a normal day. This slurry will be tested for viscosity and textural differences using the standard recipe consisting of just ground dry petfood and water alone and a second recipe consisting of ground dry petfood, water, and the Inventive supplement added.
Measure the viscosity of the resultant slurries over a range of viscometer rotor speeds.
To evaluate the impact of a change in pH has between on the viscosity of the two test recipes. The change in the pH of the test formulations will be set up to mimic the changes of pH during the digestion process. The pH ranges selected were approximately 2.2, 3.0, 4.0, 5.5, 6.5, and 7.5.

### Method and Materials

Many researchers have attempted to design a bench experiment that mimics the viscosity of the digesta at each stage of the digestive process. However, as the inventive technology is based on a series of insoluble fibres, Montmorillonite, dicalcium phosphate and vegetable starches, which are largely unaffected by digestive processes, the inventors proposed that a series of bench experiments where retail dry dog foods could be ground up added to water to form a slurry. The base petfood-water slurry combination could be tested with and without the addition of the inventive formulation.

These slurries would simulate as closely as possible the ratios of water, food, and inventive formulation as would be experienced by a dog after consuming a normal meal. These slurries will be tested for viscosity over a range of shear rates. The viscosity test examined the slurries of the ground dog food with water with the addition of the inventive ‘Dig-In’ formulation, allowing comparison of the results with the viscosity graphs generated by the ground dog food plus water alone.

The viscosity test was run for a range of pH's from 2.2 to 7.5. to model the pH range of the canine digestive system. The preparation of the slurries was carried out identically.

### Method:

The formulation for the Inventive (Dig-In) Supplement was prepared according to the formulation supplied in Table 1 and is given in Table 5.

TABLE 5
Typical Recipe from Patent Application and Recipe
used for Viscosity Trial

| Ingredient | Mass % (Dry) |
|---|---|
| Yeast and Yeast products (including inactivated | 64% |
| whole cells and specific high protein cell wall | |
| fragments from Saccharomyces cerevisiae) | |
| Potato flour | 5.0% |
| Inulin Fibre | 4.0% |
| Montmorillonite mineral clay | 15.0% |
| Glucose | 6.0% |
| Di-calcium Phosphate | 2.0% |
| Natural Flavours | 2.0% |
| Vitamin C | 2.0% |

### Preparation of the Test Recipes

The following combination of the Petfood+water (Recipe 2) and the combination of the inventive DIG supplement+Petfood+Water (Recipe 1) is close to that consumed by a dog at a single meal and suitable for viscosity testing. Please note that the volume of water was held constant between the two mixes.

TABLE 6
Recipes used for Viscosity Trials

| | Recipe 1-DIG | Recipe 2-PF2 |
|---|---|---|
| | (DIG + Petfood + | (Petfood PF2 + |
| Ingredients | Water) | water) |
| DIG (Inventive Dig- | 2.25% | 0 |
| In Supplement) | | |
| Ground dry dogfood | 25.25% | 28.00% |
| Water | 72.00% | 72.00% |

### Equipment:

Brookfield Model Viscometer Model: RVDV-I+ using spindle #3 for all tests.
Water bath recirculating at constant 52° C.
Lab grinder and 1 mm stainless steel sieves
Digital scale 1000 g accurate to 0.01 g
Beakers
Pipettes and bulbs

### Materials

Petfood purchased from local retail store. For the trial, the petfood has been named PF2.
Solutions used for pH adjustment: Standardised 1M Hydrochloric acid & 1M Sodium Hydroxide solution supplied by LabCo Scientific.
Dig-In formulation supplied by HiCare Healthfoods Pty Ltd. (Note: DIG is the name used for HiCare Dig-In formulation during the trial. DIG is a shortened form of the brand name Dig-In.)

### Preparation of Slurry:

Weighed required amount of PF2 into beaker.

With DIG recipe, blend dry mix until consistent.

Add required water less the solution required for acid or alkali addition.

Manual blend for 2 minutes.

Add Acid or alkali solution as required by recipe to deliver the required pH between 2.2 and 7.5 in approximate 1 pH unit steps.

Allow to stand for >30 minutes to ensure hydration.

Place in water bath and allow to warm to at least 40° C.

Manual Mix for 1 minute.

Adjust temperature until target of 50° C.

Measure pH & record on Recipe Sheet.

Measure viscosity with range of speed from 0.5 RPM using Spindle #3.

Increase speed of Brookfield from 0.5 to 1 RPM and wait 2 minutes—record both Viscosity and % Motor load.

Repeat for speeds 2.0, 2.5, 4.0, 5.0, 10.0, 20.0, 50.0, & 100.0 RPM.

Check final pH and remove and clean spindle.

Repeat test with fresh material in slurry with the pH adjusted to fit the established pattern.

### Results

Table 6 below shows the viscosity results for the first recipe #1 DIG for the following range of pH's: 2.20, 3.10, 3.98, 5.30, 6.50, and 7.58.

TABLE 7
Viscosity vs RPM for the DIG + PF2 + Water recipe.

| Spindle Number: | | #3 | | #1 DIG Recipes | | | | | Product Temperature = | | | 49.5 50.5 |
|---|---|---|---|---|---|---|---|---|---|---|---|---|
| Viscometer used: | | Brookfield DV-I+ | | Viscometry Data | | | | | Water Bath Temp = | | | 52.5 |
| Test No. | DIG-4 | DIG-4 | DIG-3 | DIG-3 | DIG-2 | DIG-2 | DIG-1 | DIG-1 | DIG-6 | DIG-6 | DIG-7 | DIG-7 |
| RPM | DIG | DIG | DIG | DIG | DIG | DIG | DIG | DIG | DIG | DIG | DIG | DIG |
| | pH = | pH = | pH = | pH = | pH = | pH = | PH = | pH = | pH = | pH = | pH = | PH = |
| | 2.20 | 2.20 | 3.10 | 3.10 | 3.98 | 3.98 | 5.30 | 5.30 | 6.50 | 6.50 | 7.58 | 7.58 |
| | VISC | % M | VISC | % M | VISC | % M | VISC | % M | VISC | % M | VISC | % M |
| 0.5 | 33800 | 16.9 | 2440 | 12.2 | 14800 | 7.4 | 5000 | 2.5 | 3200 | 1.6 | 5400 | 2.7 |
| 1.0 | 19100 | 19.1 | 16000 | 16.0 | 9800 | 9.8 | 3400 | 3.4 | 2400 | 2.4 | 5500 | 5.5 |
| 2.0 | 14550 | 29.1 | 10250 | 20.5 | 7250 | 14.5 | 2450 | 4.9 | 1950 | 3.9 | 5900 | 11.8 |
| 2.5 | 13440 | 33.6 | 7200 | 18.0 | 7880 | 19.7 | 2760 | 6.9 | 1960 | 4.9 | 5560 | 13.9 |
| 4.0 | 10550 | 42.5 | 6400 | 25.6 | 6725 | 26.9 | 2375 | 9.5 | 1875 | 7.5 | 5675 | 22.7 |
| 5.0 | 9520 | 47.6 | 6300 | 31.5 | 5520 | 27.6 | 2180 | 10.9 | 1880 | 9.4 | 4940 | 24.7 |
| 10.0 | 6580 | 65.8 | 5000 | 50.0 | 3990 | 39.9 | 1680 | 16.8 | 1350 | 13.5 | 3090 | 30.9 |
| 20.0 | 4685 | 92.5 | 3410 | 68.2 | 2515 | 50.3 | 1030 | 20.6 | 830 | 16.6 | 1850 | 38.0 |
| 50.0 | | | 1918 | 95.9 | 1442 | 72.2 | 588 | 29.4 | 498 | 24.9 | 1128 | 56.7 |
| 100.0 | | | | | | | 392 | 39.2 | | | 787 | 78.7 |

The second recipe (Recipe #2) consists of dry ground petfood plus water. The results of the viscosity at different spindle rpm and pH levels are shown in Table 8.

TABLE 8
Viscosity vs RPM for the Std PF2 and water recipe

| Spindle Number: | | #3 | | #2 PF2 Std Recipes with Water | | | | | Product Temperature = | | | 49-50.5 |
|---|---|---|---|---|---|---|---|---|---|---|---|---|
| Viscometer used: | | Brookfield DV-I+ | | Viscometry Data | | | | | Water Bath Temp = | | | 52.5 |
| Test No. | STD-4 | STD-4 | STD-3 | STD-3 | STD-2 | STD-2 | STD-1 | STD-1 | STD-6 | STD-6 | STD-7 | STD-7 |
| RPM | Std PF2 | Std PF2 | Std PF2 | Std PF2 | Std PF2 | Std PF2 | Std PF2 | Std PF2 | Std PF2 | Std PF2 | Std PF2 | Std PF2 |
| | pH = | pH = | pH = | PH = | pH = | pH = | pH = | pH = | pH = | PH = | pH = | PH = |
| | 2.38 | 2.38 | 3.25 | 3.25 | 4.03 | 4.03 | 5.37 | 5.37 | 6.56 | 6.56 | 7.55 | 7.55 |
| | VISC | % M | VISC | % M | VISC | % M | VISC | % M | VISC | % M | VISC | % M |
| 0.5 | 105000 | 52.5 | 58000 | 29.0 | 29400 | 14.7 | 18600 | 9.5 | 19400 | 9.7 | 66600 | 33.3 |
| 1.0 | 68200 | 68.2 | 37900 | 37.9 | 17200 | 17.1 | 11300 | 10.7 | 9100 | 9.1 | 34400 | 34.4 |
| 2.0 | 44500 | 89.0 | 26000 | 52.0 | 13450 | 26.9 | 6700 | 13.0 | 8400 | 16.9 | 18100 | 36.2 |
| 2.5 | 38120 | 95.3 | 22760 | 56.9 | 10280 | 25.7 | 6500 | 16.0 | 8680 | 21.7 | 18640 | 46.6 |
| 4.0 | | | 17500 | 70.0 | 8675 | 34.7 | 4125 | 16.5 | 7525 | 30.1 | 17050 | 68.2 |
| 5.0 | | | 11500 | 77.9 | 8020 | 40.3 | 3700 | 18.5 | 8060 | 40.4 | 14140 | 70.7 |
| 10.0 | | | | | 6020 | 60.8 | 3050 | 30.5 | 5860 | 58.6 | | |
| 20.0 | | | | | 4435 | 88.7 | 2180 | 43.6 | 3950 | 79.0 | | |
| 50.0 | | | | | | | 1289 | 65.0 | | | | |
| 100.0 | | | | | | | 859 | 85.9 | | | | |

### Discussion

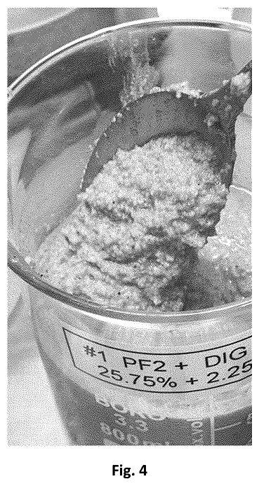

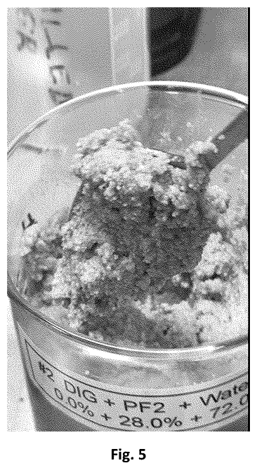

The first observation noted by the experimenter was the marked difference in the consistency of the slurry containing the DIG (Inventive formulation) ingredient together with the standard petfood and water (recipe 1) against the standard petfood plus water (recipe 2). FIGS. 4 and 5 shows the difference.

The slurry made using the inventive DIG supplement showed an easier flowability and smaller particle size. The slurry made using just the petfood and water alone showed a lumpy consistency and decidedly non-flowable nature. The observed difference between the two slurries shows that the addition of the inventive formulation has helped to smooth the rheology of the standard formulation. This observation was backed up by the viscosity results above.

The rate at which food passes through the digestive system is governed by many factors. It is reasonable to assume that as food passes into digesta during the absorption process, that the material will experience many changes in viscosity caused by many factors such as the addition of enzymes, other chemicals, and water to the peristaltic motion of the gut. The rheological properties of digesta from the small intestine of six pigs has previously been determined to give a shear rate of 1 s⁻¹ [Hardacre, 2018].

Using the simplified conversion equation and factors provided in Mitschka P., 1982 [Mitschka, 1982], the closest spindle speed which can deliver a shear rate of 1 s⁻¹ was calculated to be 2.0 RPM for both the inventive DIG and PF2 slurries.

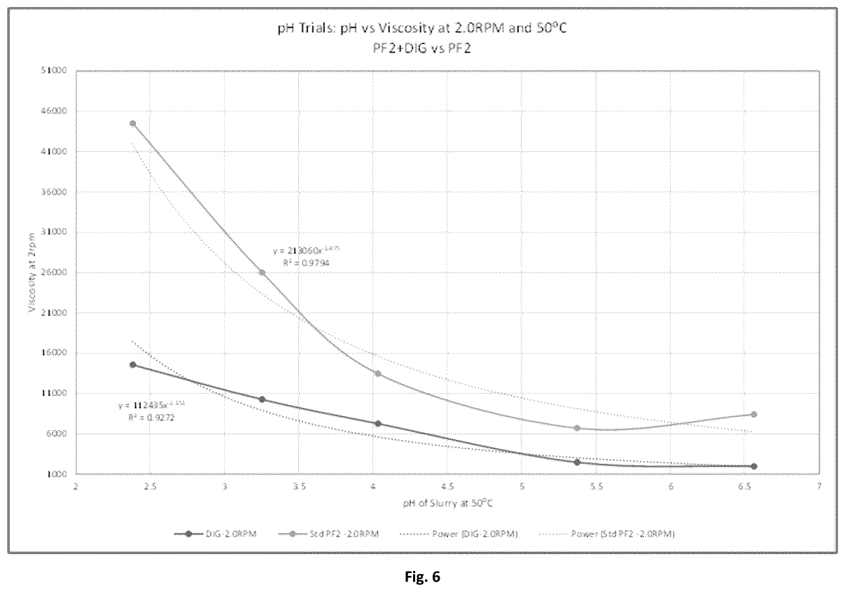

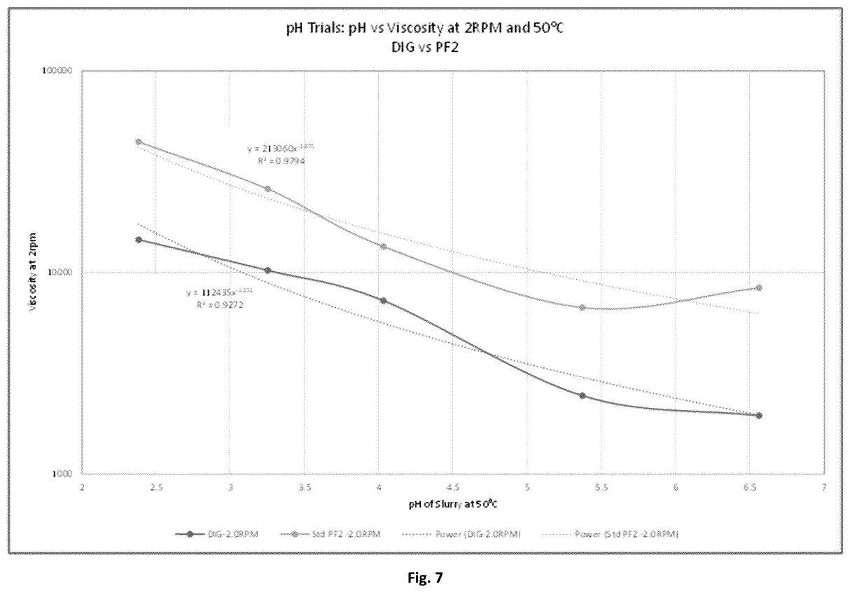

FIGS. 6 and 7 shows the differences between the viscosity for the range of pH's tested for the PF2 slurry with and without the inventive DIG supplement. Specifically, the inventive supplement has the effect of decreasing the viscosity of the ingesta by comparison with the control.

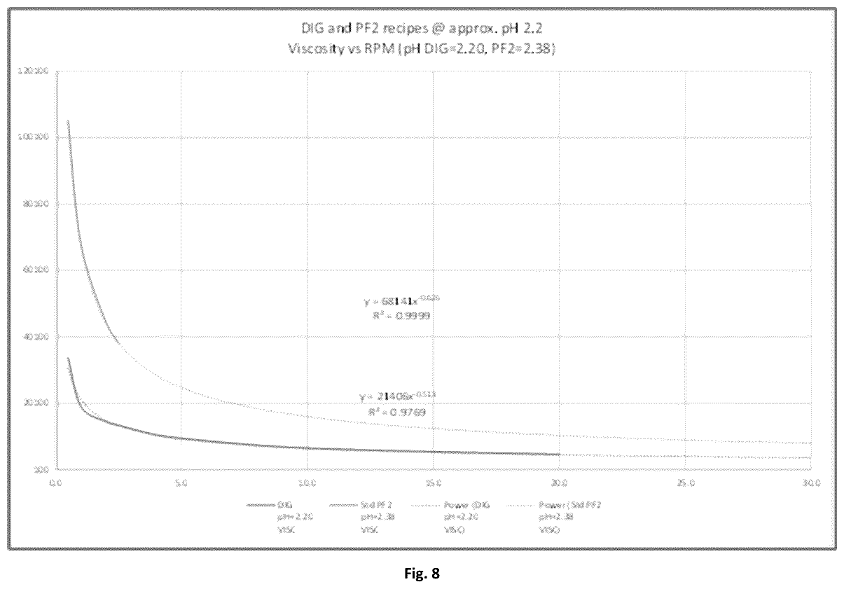

The viscosity results for each pair of reading of Recipe 1 (DIG+PF2+Water) and Recipe 2 (Std PF2+water) at each pH point are presented here graphically (in FIGS. 8 to 19). The spindle speeds were changed in discrete steps from 0.5 RPM up to 100 RPM for each pH pair. The speed was changed only after the previous viscosity reading was taken after a full 2 minutes.

FIG. 8 is a Graph of Viscosity vs RPM for Recipes #1 (DIG) @ pH2.2 and #2 (Std PF2) @ pH 2.38.

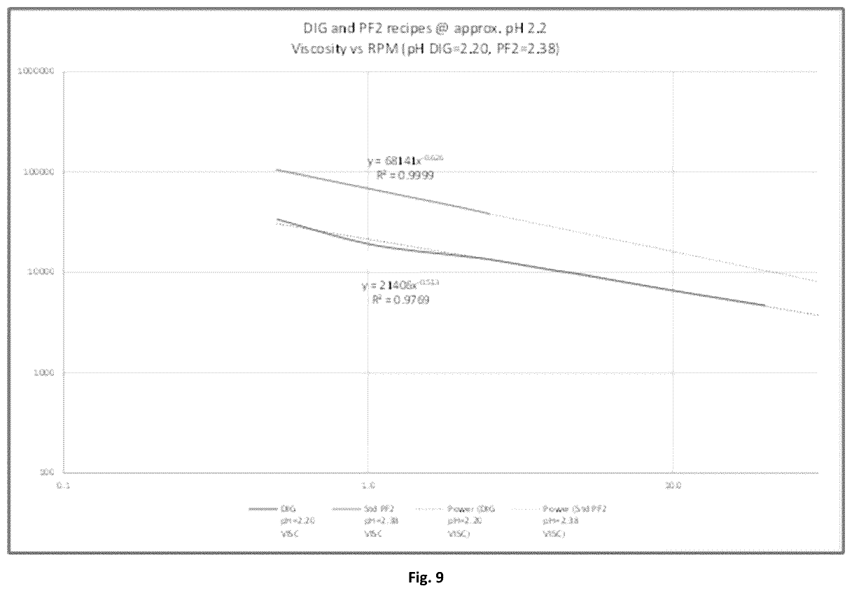

FIG. 9 is a Log-Log Graph of Viscosity vs RPM for Recipes #1 (DIG) @ pH2.2 and #2 (Std PF2) @ pH 2.38.

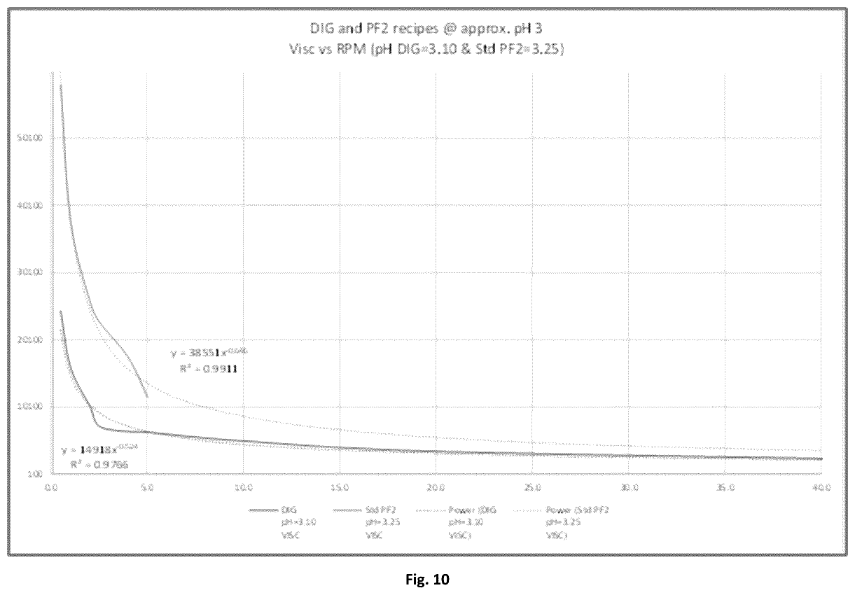

FIG. 10 is a graph of Viscosity vs RPM for Recipes #1 (DIG) @ pH3.10 and #2 (Std PF2) @ pH 3.25.

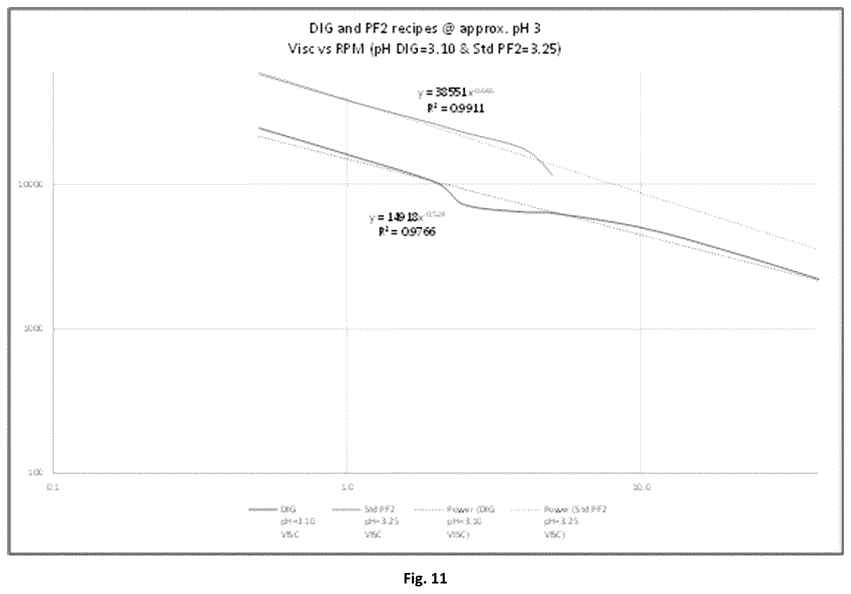

FIG. 11 is a Log-Log Graph of Viscosity vs RPM for Recipes #1 (DIG) @ pH3.10 and #2 (Std PF2) @ pH 3.25.

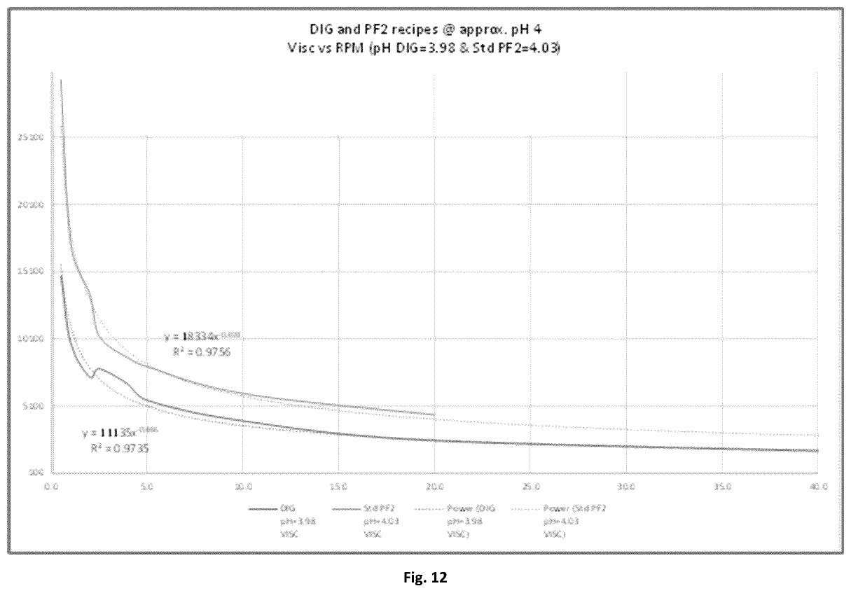

FIG. 12 is a Graph of Viscosity vs RPM for Recipes #1 (DIG) @ pH3.98 and #2 (Std PF2) @ pH 4.03.

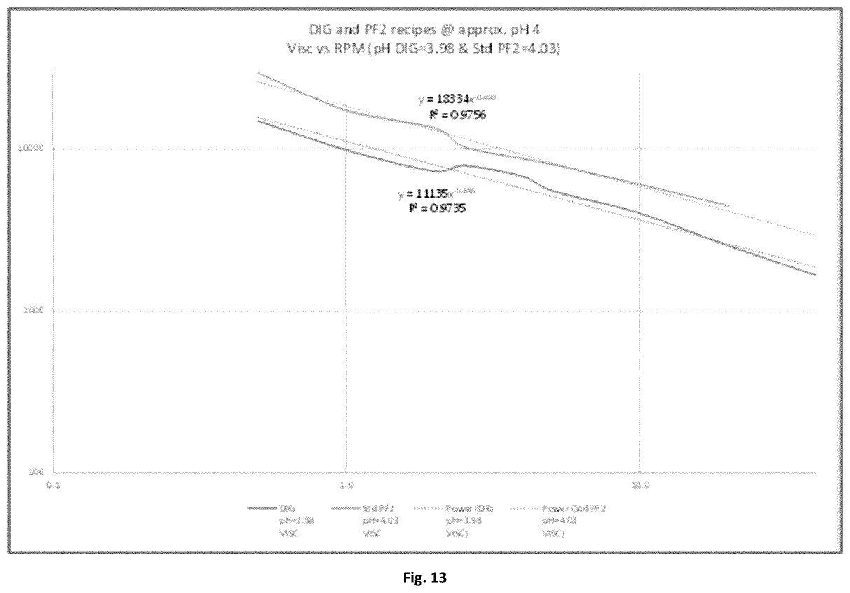

FIG. 13 is a Log-Log Graph of Viscosity vs RPM for Recipes #1 (DIG) @ pH3.98 and #2 (Std PF2) @ pH 4.03.

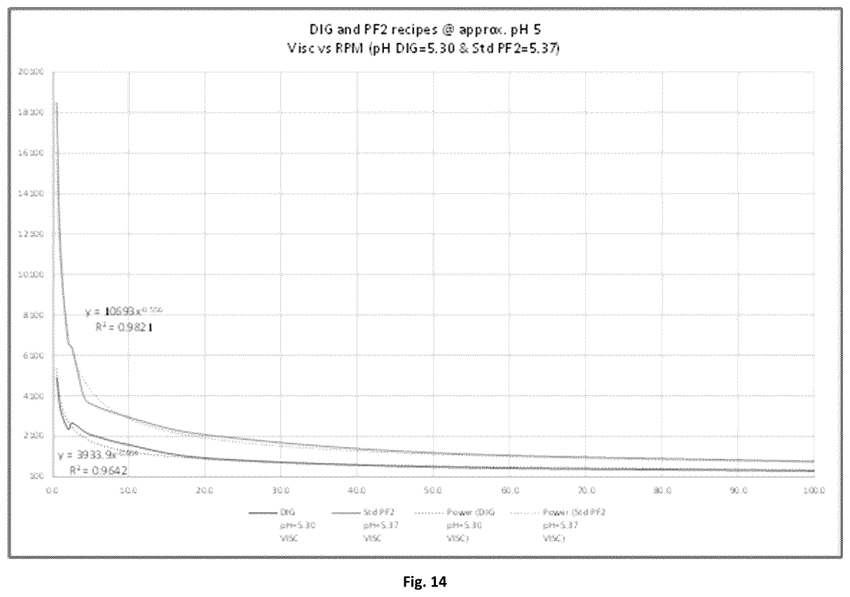

FIG. 14 is a graph of Viscosity vs RPM for Recipes #1 (DIG) @ pH5.30 and #2 (Std PF2) @ pH 5.37.

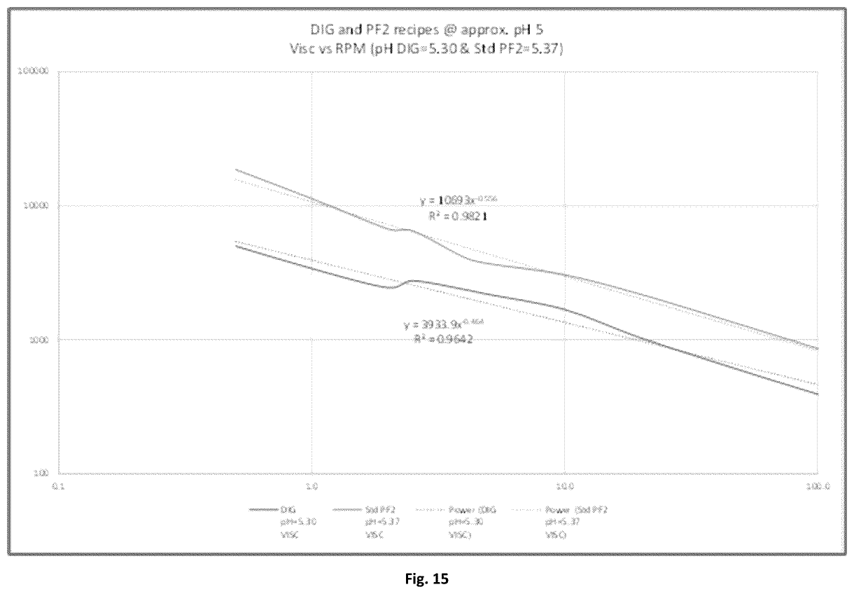

FIG. 15 is a log-Log Graph of Viscosity vs RPM for Recipes #1 (DIG) @ pH5.30 and #2 (Std PF2) @ pH 5.37.

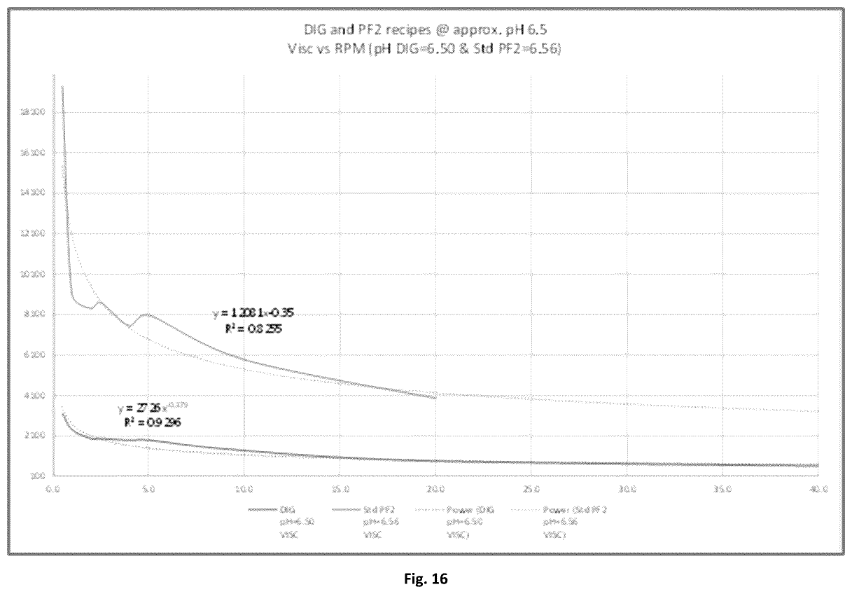

FIG. 16 is a graph of Viscosity vs RPM for Recipes #1 (DIG) @ pH6.50 and #2 (Std PF2) @ pH 6.56.

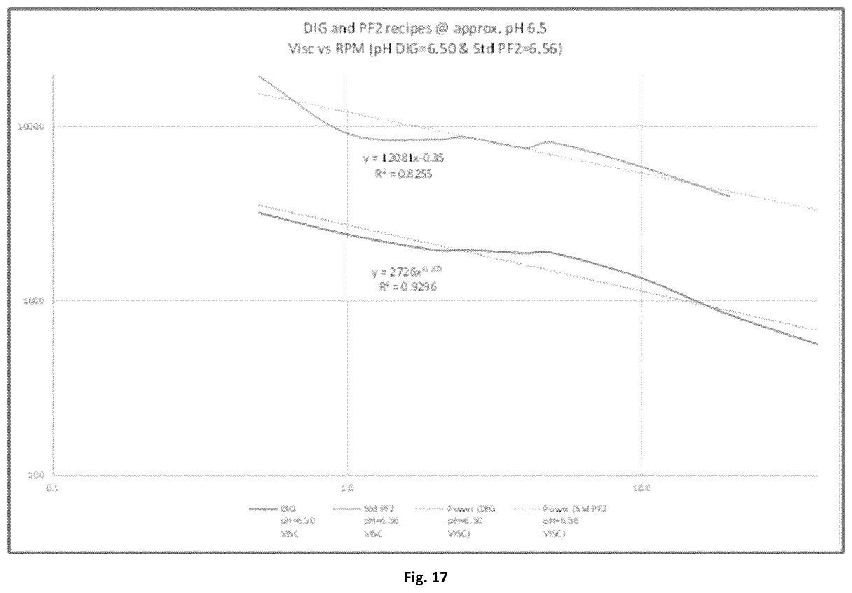

FIG. 17 is a Log-Log Graph of Viscosity vs RPM for Recipes #1 (DIG) @ pH6.50 and #2 (Std PF2) @ pH 6.56.

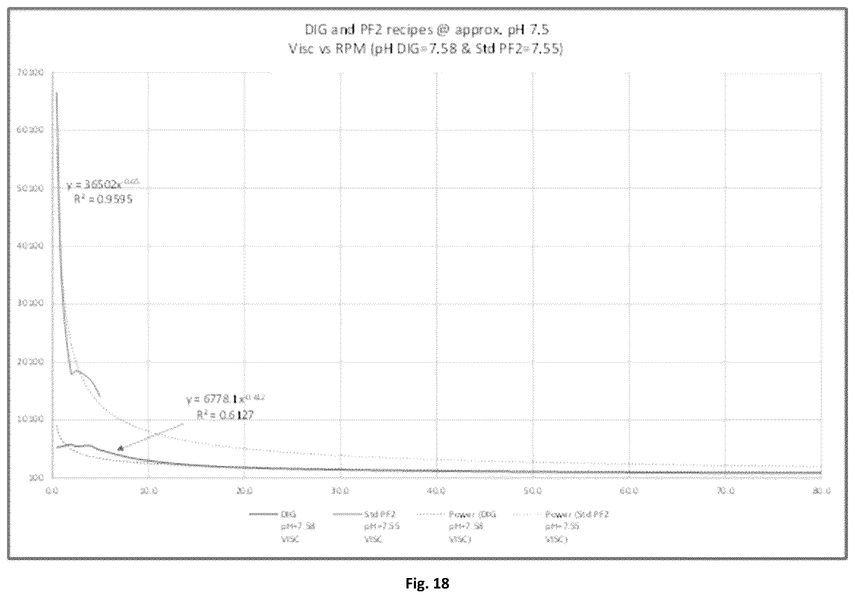

FIG. 18 is a graph of Viscosity vs RPM for Recipes #1 (DIG) @ pH7.58 and #2 (Std PF2) @ pH 7.55.

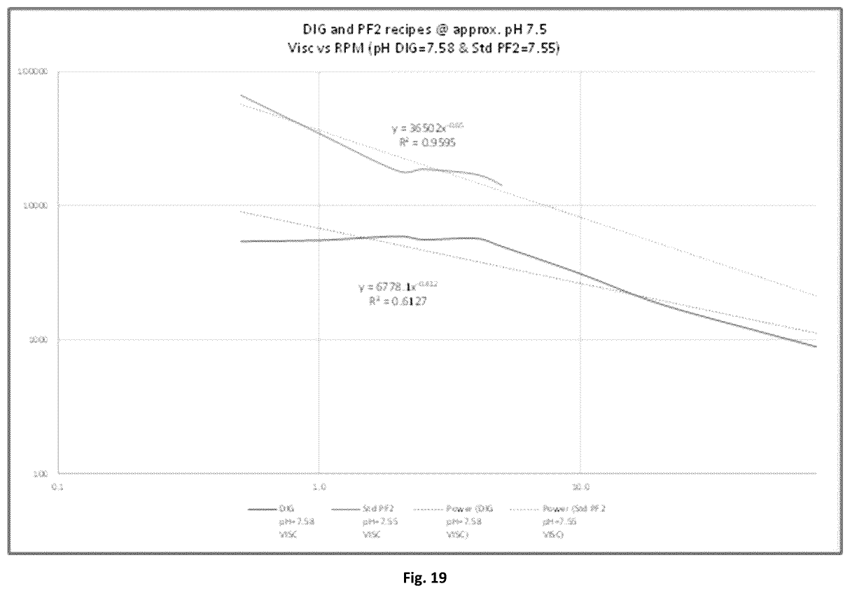

FIG. 19 is a Log-Log Graph of Viscosity vs RPM for Recipes #1 (DIG) @ pH7.58 and #2 (Std PF2) @ pH 7.55.

The slurry made up of the pet food and water with and without the DIG additive displayed non-Newtonian flow characteristics of a shear thinning fluid.

At every pH point, the viscosity of the slurry containing PF2, and DIG was lower than that of the standard petfood PF2. It was noted that at all pH's reading from 2.2 to 6.5, the texture of the test sample containing the inventive DIG was smoother and more evenly dispersed than that of the standard product and water alone.

At every step of the laboratory test where the pH is being modified to reflect the pH of the gut during digestion, the consistency and viscosity of the digesta has been significantly smoothed by the inventive additive, resulting in an ease of blending and thorough mixing of the digesta. This is a significant contributor to the efficient combining of food particles with enzymes and the uptake of nutrients, recovery/release of water, and the consistency of the final stool.

The ease of blending and complete mixing will also enable the ingredients in the inventive formulation that are designed to target and remove mycotoxins and pathogens to work more effectively and earlier in the digestive process, thus relieving allergic strain on the system.

### Example 3—Gut Microbiome Test

A trial was conducted on a group of dogs. The intent was to compare the effects of two different additives, one of which represents the inventive composition, on the microbiome and overall health of these dogs. The following example focuses on the changes in microbiome composition following treatment with the inventive composition.

The experiment comprised three stages:
(1) Dogs were selected, and their health was assessed. After the selection was complete, all recruited dogs were fed a standardised diet for an initial stabilisation period (day 1);
(2) Pre-intervention measurements were conducted. At the end of the stabilisation period and prior to supplementation (day 12 of diet adjustment), blood and stool samples were taken and sent for analysis. The recruited dogs were then randomly assigned to receive the inventive product in supplementation to the standard diet;
(3) After supplementation cessation (day 24) the dogs were given a further health assessment and measured for the same metrics.

Stage 1: Animal Selection and Diet Normalisation

A panel of 12 dogs was selected from the available pool of animals. Each selected dog was given an extensive Veterinary examination before the trial commenced. The Vet personally supervised the entire trial. Each day observations were taken for each animal. Observations included demeanour, stool appearance, skin, and eyes. Stool observations were recorded using the Waltham Faeces Scoring System.

To standardise the environment of the test panel, all dogs were housed in individual pens for the duration of the trial.

Each dog was fed the same standardised diet for the duration of the trial. The diet consisted of Kangaroo meat and a typical kibble. The amount of food fed to each animal was varied depending on each dog's specific calorific requirements depending on age, weight, life stage and activity level etc.

The dogs were fed the standard diet for an initial stabilisation period of 12 days.

Stage 2: Initial Sample Collection and Commencement of Additive Trial

On the 12th day and prior to the commencement of Additive inclusion, the first batch of stool and blood samples were taken from each animal. These samples serve as the Pre-Trial marker for the start of the investigation. The samples were marked using the following identification: “Dog Number_Stage 2” (for example, the first (or pre-trial) sample set from Dog 2 would be identified with the label “Dog2_Stage2”).

The panel was then broken into two cohorts. From this cohort, 6 dogs were randomised to the inventive product, which was added to their daily ration of the standard diet. The dogs were fed these meal combinations for a further 12 days. Each day, observations and stool score were recorded on each animal.

Stage 3: Trial Conclusion and Animal Evaluation

On the 24th day, the trial was concluded. The post-trial blood and stool samples were collected from each dog and sent for analysis. The same style of identification for animal number and stage was used for these samples. But with the stage number has incremented to 3, e.g., “Dog Number_Stage 3”, thus, the post-trial sample set from Dog 2 would be identified with the label “Dog2_Stage3”. The dogs were given a final Veterinary examination and each animal's weight and general condition score was recorded.

Sample Analysis

Blood samples were tested for Full Blood Profile, Differential Blood Counts and Liver enzymes. Blood sample analysis was carried out by the University of Adelaide, Veterinary Diagnostic Laboratory. The stool samples were sent to the Australian Genomic Research Facility (AGRF). The AGRF conducted 16S Microbial Profiling on the stool samples to identify and classify the relative proportion of bacterial and/or fungal microorganisms present in metagenomic communities.

The specific tests that were carried out by the AGRF were Microbial Profiling (1-93, Pooled Plate) 16S: 27F-519R and Microbial Profiling (1-93, Pooled Plate) 16S: 341F-806R.

The following analysis aimed to identify differences in the dogs' gut microbiome composition pre- and post-treatment with the inventive product and their potential significance for the dog's health outcomes.

Material and Methods

Health metrics, blood and urine results as well as sequence and microbial abundance data were provided by the inventors to the assessor. All data were concatenated by the assessor in a unique database and were evaluated at different taxonomic levels. As the number and depth of read can vary between samples during sequencing, crude abundances were adjusted to percentage of abundance of the total microbial population.

A first analysis was conducted at a phylum level, as this is the approach the most commonly used in research and provides a quick snapshot on gut health and microbial population composition. Upon findings at the phylum level, order-level and species-level analyses were conducted separately within selected phyla. This was done to provide clearer figures for this report.

A preliminary statistical report was also communicated to the assessor. In the preliminary report, a paired t-test was computed to evaluate the significance of changes in microbial abundance between the start (referred herein as initial) and the end of the trial (referred herein as post). This report provided a list of genera (or higher-level taxa) whose abundance changed significantly after supplementation. These taxa were selected to run an additional analysis in the present study.

Important note: the effect evaluated in this example was limited to a difference in percentage of change between the start and the end of the trial. This is due to a low number of participants. It is well established that inter-individual variations in gut microbiome composition can be quite important depending on various factors such as age. Therefore, a minimum of 15 individuals per treatment arm is recommended to effectively identify trends following a treatment. As the present study contained 6 dogs in total other statistical analyses would not be relevant. It is also important to note that one of the dogs did not complete the trial and the final cohort comprised 5 dogs.

Results

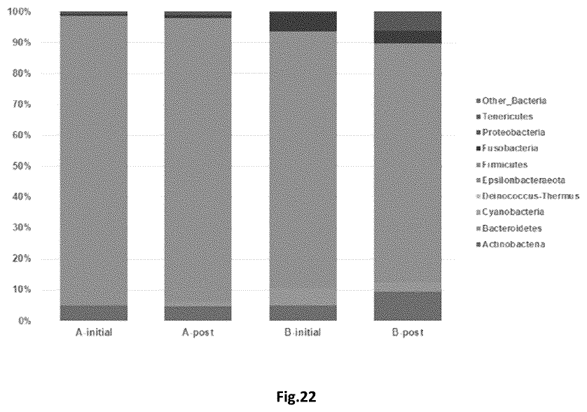

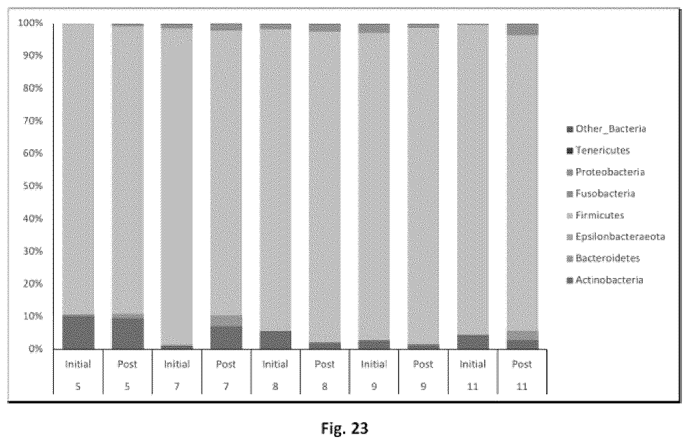

At the phylum level (highest taxonomic level considered for analysis), Firmicutes dominated the microbial population. The initial proportion of Actinobacteria and Proteobacteria differed between dogs (FIG. 22). The difference in microbial composition could be due to differences in age, which have been proved to influence the gut microbiome in dogs (i.e., group A mean age=2.4 years, range: 1 to 6 years). The phylum-level profile of the gut microbiome of the recruited dogs is similar to that published in the literature, where the main phyla represented are Firmicutes, Fusobacteria, Bacteroidetes, Proteobacteria and Actinobacteria. It was established that the core microbiome of healthy dogs is dominated by three phyla: Firmicutes, Bacteroidetes and Fusobacterium. This pattern was observed in the recruited dogs with significant numbers of Actinobacteria also recorded (FIG. 22, FIG. 23).

Individual variations in microbial population composition are common and was observed in the current cohort, explaining the inter-individual differences of profile at baseline.

Gut Actinobacteria have been shown to be essential in supporting the immune system by helping the maintenance of gut homeostasis. In this cohort, this phylum represented 5.0% of the microbial population prior to the intervention and 4.7% of the total population post-intervention. This constitutes a 4.5% reduction. The inventive product appears to reduce the growth of Actinobacteria.

It is important to note that the inter-individual differences at the start of the trial in terms of Actinobacteria abundance may induce a bias in the change observed.

Bacteroidetes and Firmicutes are the main phyla represented in gut microbiomes. In humans Firmicutes have been associated with negative health outcomes such as obesity and type-II diabetes, while Bacteroidetes have been associated with healthy individuals. The lower the Firmicutes/Bacteroidetes (F/B) ratio is, the healthier an individual is deemed to be. In group A, the F/B ratio was 833 prior to intervention and 58 post intervention. It has been demonstrated that some species of Firmicutes, while associated to disease in humans, are quite often present in healthy dogs. The abundance of the two commonly most abundant Bacteroidetes genera, namely Bacteroides and Prevotella vary greatly between dogs.

In the present cohort, Bacteroidetes represented 0.1% of the total microbial population before intervention and 1.6% after intervention. This corresponds to a 1,329% increase. The inventive product seems to promote the growth of Bacteroidetes.

Concurrently Firmicutes represented 94.9% of the total microbial population before intervention and 93.6% post-intervention. This corresponds to a 1.4% reduction. The inventive product reduces the growth of Firmicutes in the gut. It appears that the inventive product helps to reduce the F/B ratio by simultaneously increasing the concentration of Bacteroidetes and reducing the number of Firmicutes.

Gut Fusobacteria are strict anaerobes and rare agents of severe diseases in humans, but commonly found in healthy dogs. In the present cohort, this phylum represented 0.4% of the total microbial population before intervention and 1.1% post-intervention. This represents a 161.0% increase. The inventive product seems to promote the growth of Fusobacteria.

Gut Proteobacteria consume oxygen and therefore have a key role in the colonisation of the gut by strict anaerobes essential to healthy gut function. In the cohort analysed, this phylum represented 1.0% of the total microbial population pre-intervention and 1.1% post-intervention. This constitutes a 12.2% increase. The inventive product appears to promote the growth of Proteobacteria in the gut.

At the phylum level, the inventive product increases the concentration of groups of bacteria traditionally associated with healthy gut function, such as Bacteroidetes and Proteobacteria, while reducing the abundance of bacteria associated with dysbiosis such as Firmicutes.

Analysis within the Firmicutes phylum

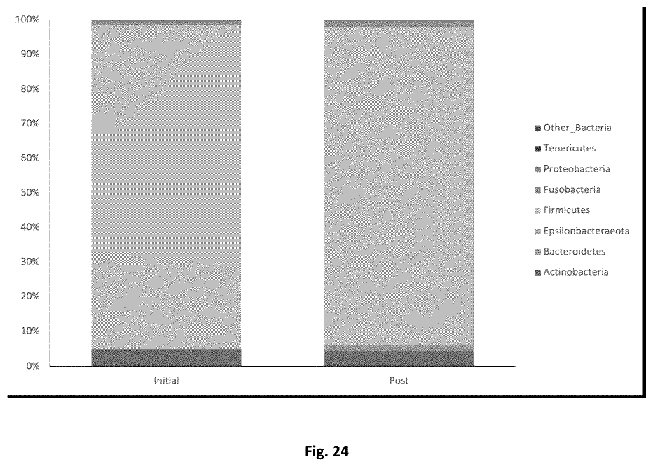

Firmicutes were the dominant phylum pre- and post-treatment. Within this phylum, Clostridia was the dominant class and Clostridiales was the dominant order (FIG. 24). At the order level Lactobacillales were the main representatives within the Bacilli class, while Clostridiales and Erysipelotrichales were the only representatives of the Clostridia and Erysipelotrichia classes respectively.

In the present cohort, Lactobacillales represented 1.2% of the total Firmicutes population preintervention and 0.2% post-intervention. The inventive product seems to reduce the growth of Lactobacillales.

Clostridiales represented 91.3% of the total Firmicutes population pre-intervention and 83.0% postintervention. This corresponds to a 9.0% decrease. The inventive product seems to reduce the growth of Clostridiales. Clostridiales include several potential pathogens.

Erysipelotrichales represented 7.5% of the total Firmicutes population pre-intervention and 16.5% post-intervention. This corresponds to a 119.8% increase. The inventive product seems to promote the growth of Erysipelotrichales.

Peptoclostridium sp., Blautia sp., an uncultured species of Lachnospiraceae, Clostridium perfringens, an uncultured species of Clostridium senso-stricto 1, Ruminococcus troques group and Faecalibacterium sp. were the main species or group of species within the Clostridiales order to be identified in the samples; with Peptoclostridium sp. and Blautia sp. being the dominant species before and after intervention.

Analysis at the Order Level within the Proteobacteria Phylum

Proteobacteria represented overall a small proportion of the microbial diversity (FIG. 22, FIG. 23). The main orders within the Proteobacteria phylum represented in the recruited dogs were Enterobacteriales, Aeromonadales and Betaproteobacteriales, with Enterobacteriales being the dominant order.

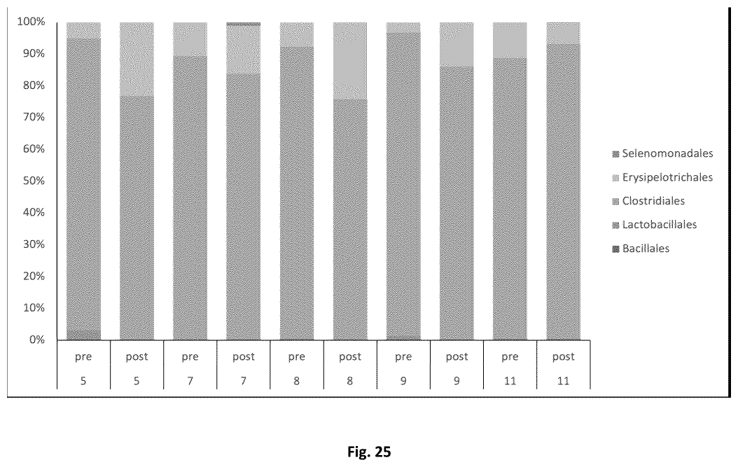

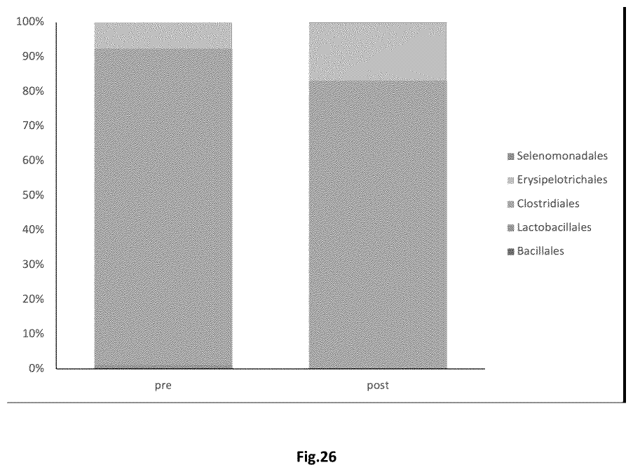

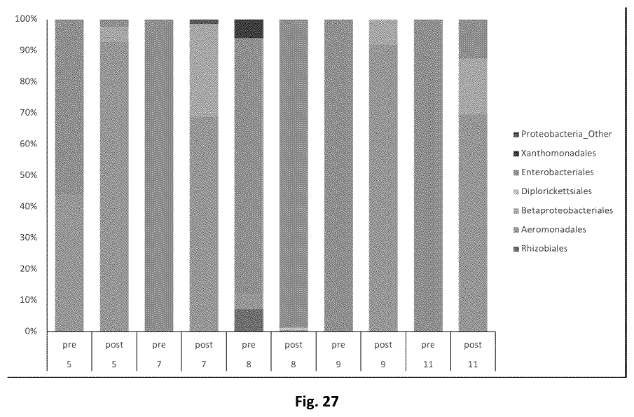

FIG. 24 shows the diversity of Firmicutes at the order level for each dog pre- and post-treatment with the inventive supplement. FIG. 25 shows the diversity of Firmicutes at the order level pre- and post-treatment with the inventive supplement. FIG. 26 Diversity of Proteobacteria at the order level for each dog pre- and post-treatment with the inventive supplement. FIG. 27 shows the diversity of Proteobacteria at the order level pre- and post-treatment with the inventive supplement.

In the cohort studied, Enterobacteriales represented 87.6% of the total. The inventive supplement product seems to reduce the growth of Enterobacteriales. High concentrations of some Enterobacteriales such as Escherichia coli and other Enterobacteriaceae in dog faecal samples have been associated with chronic enteropathies. In the present samples this order represented a maximum of 6% of the total microbial population.

Aeromonadales represented 9.7% of the total Proteobacteria population pre-intervention and 64.6% post-intervention. This corresponds to a 565.0% increase. The Inventive prebiotic seems to promote the growth of Aeromonadales. It was demonstrated that the abundance of Aeromonadales increases when dogs were fed a diet high in inulin (Beloshapka 2013).

Betaproteobacteriales were not detected pre-intervention and represented 12.0% of the total Proteobacteria population post-intervention. The Inventive supplement appears to promote the growth of Betaproteobacteriales.

Overall, the Inventive supplement appeared to increase the abundance of proteobacteria associated with inulin intake and reduce the abundance of Entebacteriales, which are associated with dysbiosis and gastro-intestinal diseases.

Analysis on Selected Species:

The preliminary statistical report indicated that the abundance of the following taxa changed after the introduction of additives:
Ruminococcus (genus from Lachnospiraceae family and the Clostridiales order, Firmicutes phylum);
Lachnospiraceae (family from the Clostridiales order, Firmicutes phylum);
Peptostreptococcaceae (family from the Clostridiales order, Firmicutes phylum);
Anaerobiospirillum (genus from the Succinivibrionaceae family and Gammaproteobacteria order, Proteobacteria phylum);
Other unspecified Succinivibrionaceae (from the Gammaproteobacteria order, Proteobacteria phylum);
Unspecified Clostridiales (order from the Firmicutes phylum)
Erysipelotrichaceae (family from the Erysipelotrichales order, Firmicutes phylum)
Butyricicoccus pullicaecorum (species from the Ruminococcaceae family, and Clostridiales order, Firmicutes phylum)
Other unspecified Butyricicoccus (genus from the Ruminococcaceae family, and Clostridiales order, Firmicutes phylum)

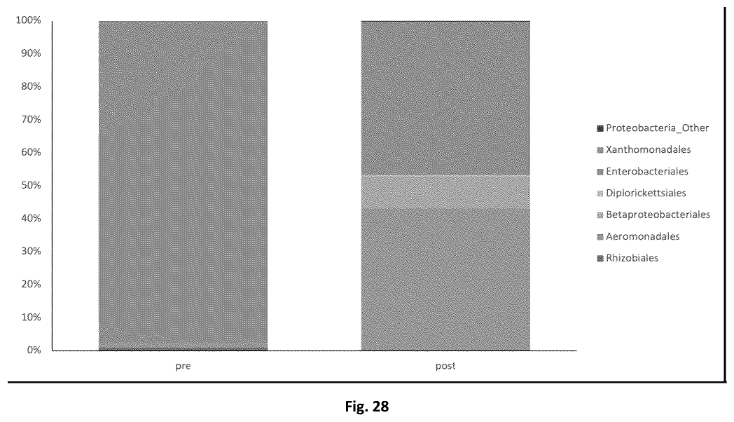

Most of these taxa fall into the Clostridiales order, which is the dominant microbial component present in the samples evaluated herein. The addition of all of the taxa listed above amounted to 64% up to 87% of the total microbial population sequenced. In most dogs, the larger contributor is the genus Paeniclostridium, which represented 36% to 41% of the total microbial population (FIG. 28). While the species Paeniclostridium sordellii has been associated to gastro-enteric diseases in humans and horses, it is unclear whether this species affects dogs the same way. Only small quantities of this species were detected in some of the recruited dogs, representing 0 to 0.37% of the total microbial population sequenced. The other two major contributors to this group of selected taxa are the genus Blautia (from the Lachnospirales order, Firmicutes phylum) and the Erysipelotrichaceae family. In humans, Blautia is associated with healthy gut functions. In dogs the abundance of Blautia spp. and Turicibacter (Erysipelotrichaceae family) were significantly lower in individuals with chronic enteropathies, suggesting that both of these genera promote healthy gut functions in dogs.

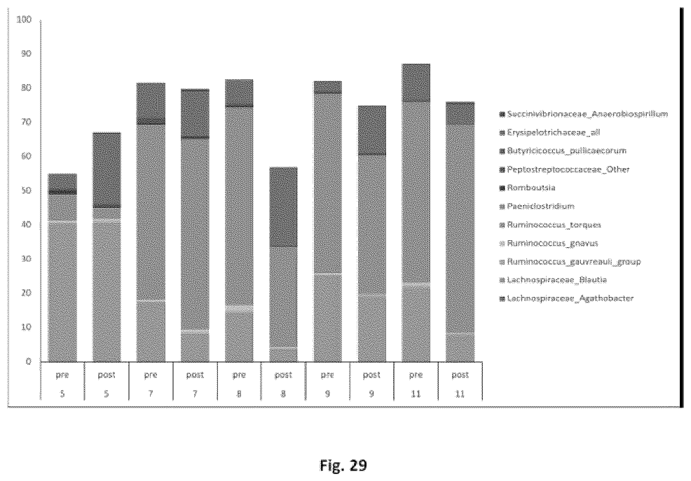

FIG. 28 shows the diversity of selected species in each dog pre- and post-treatment with the inventive supplement. FIG. 29 shows the diversity of selected species pre- and post-treatment with the inventive product.

In the cohort studied, Paeniclostridium represented 41.4% of the total microbial population preintervention and 36.3% post-intervention. This corresponds to a 12.4% reduction. The Inventive prebiotic seems to reduce the growth of Paeniclostridium. The function of most species within this genus remains unknown. It seems that post-treatment, the relative abundance of this genus is around 36-38% of the total microbial population independently of the additive provided. Some members of this genus may be essential to some gut functions.

Conclusions

The composition of the gut microbial population in the recruited dogs was similar to that of published studies. The microbiota mainly comprised members of the Actinobacteria, Bacteroidetes, Firmicutes, Fusobacteria and Proteobacteria phyla, Firmicutes being the dominant phylum pre- and post-intervention. There were differences in microbial population composition between dogs at baseline.

At the phylum level, the inventive supplement reduced the Firmicutes/Bacteroidetes ratio by simultaneously promoting the growth of Bacteroidetes and reducing the abundance of potentially harmful Firmicutes. This trend in humans would be associated with improved gut functions and health outcomes. This supplement also increased the abundance in Proteobacteria, a group associated with healthy gut functions.

Members of the Firmicutes phylum were the dominant bacterial taxa present in the analysed samples. Three main orders dominated the diversity within this phylum: Lactobacillales, Clostridiales, and Erysipelotrichales. Members of the Clostridia class were dominant, which is consistent with published data. The inventive supplement promoted the growth of Erysipelotrichales, which are associated with healthy gut functions in dogs. The supplement reduced the abundance of Lactobacillales, which are considered to be naturally good gut bacteria in dogs, and reduced the abundance in Firmicutes, which group both good gut bacteria and potential enteric pathogens.

Within the Proteobacteria phylum, there were three dominant orders: Enterobacteriales, Aeromonadales and Betaproteobacteriales. While members of the Aeromonadales order are associated with healthy gut functions, the role of Betaproteobacteriales remains unknown and the order Enterobacteriales contains known enteric pathogens such as Escherichia coli. The inventive supplement seemed to reduce the abundance in Enterobacteriales.

The inventive supplement promoted the growth of Aeromonadales, which are natural components of the gut microbiota in healthy dogs. The inventive supplement also promoted the growth of Betaproteobacteria, whose role in the gut remains unclear.

The overall most abundant taxa were the genera Paeniclostridium and Blautia and the family Erysipelotrichaceae, all part of the Frimicutes phylum. Except for one species the role of the various species of Paeniclostridium is not well documented or understood. This genus represented the highest level of abundance of all taxa. The inventive supplement reduced its growth slightly.

The inventive supplement administered reduced the growth of Blautia while it promoted the growth of Erysipelotricaceae. It seems that at least one component from this additive triggered a shift from Blautia to Erysipelotrichaceae, likely by providing a substrate more digestible by the latter. Both of these taxa are associated with healthy gut functions.

In conclusion, the inventive supplement appeared to increase the abundance of good gut bacteria and decrease the abundance of potential pathogens. While the results presented herein are indicative, the trends observed remain positive and indicate a potential benefit for the individual.

Evidence of Synergistic Effect

A significant problem for dog nutrition is the animal's tendency to scavenge, resulting in ingesting feed of unknown origin that is typically contaminated with moulds and their toxins. FIG. 20 shows the mycotoxins and their interaction with the animal.

No single toxin binder can remove all mycotoxins. It is known that montmorillonite clay only binds Aflatoxins, with limited or no binding effects on other mycotoxins. Studies in vivo also demonstrate the lack of effect of montmorillonite clay on mitigating the effects of mycotoxins other than aflatoxins. (Ramos et al. Journal of Food Protection 1996, 59(6):631-641).

Another study demonstrated that the yeast cell wall (YCW) could only absorb three of the above-mentioned six toxins (Aflatoxon B1, Ochratoxin A, Zearlenones) (Joannia-Cassan et al. Journal of Food Protection 2011 74(7):1175-1185).

The inventors prepared a mixture of these six mycotoxins known to adversely affect an animal's health. Their concentration was equivalent to that found in a finished feed. The solution was incubated with a suspension of the food additive according to the invention. The results were a better than predicted binding in the number of mycotoxins and that multiple toxins could bind simultaneously, as per table 9:

TABLE 9
Mycotoxin Binding Affinity

| | Relative Binding |
|---|---|
| Mycotoxin | affinity |
| Aflatoxin | +++++ |
| Deoxynivalenol (Don) | ++ |
| T-2 toxin | ++++ |
| Fumonisin B1 | +++ |
| Ochratoxin A | +++ |
| Zearalenone | ++++ |

[symbol]

[symbol]

indicates data missing or illegible when filed

This shows the synergistic effect of the inventive composition, in that it has the ability to produce better mycotoxin binding (all six mycotoxins) as compared to its individual components.

Impact of the composition of the invention on the immune system and cells as compared to its key ingredient—inactivated whole cells and lysed cells of Saccharomyces cerevisiae, including cell wall products from lysed cells of Saccharomyces cerevisiae.

The inventors conducted a trial to determine the effect of the inventive composition on white blood cell profile of canines. Feeding was over 2 weeks for a control diet, followed by supplementation of the control diet with known yeast cell wall (YCW) products or with the inventive composition. The neutrophil/lymphocyte (NLR) ratio was determined to indicate the level of immune stress and whether the supplement positively affected this stress (no normal range for NLR has been documented for dogs, but a ratio of 4 or less is considered normal for humans). The lower the ratio, the less stressed the immune system:

NLR range for control diet=1.44 to 4.68

NLR mean (STD) for control diet=2.53 (1.14)

NLR range for YCW supplement=1.75 to 4.04

NLR mean (STD) for YCW supplement=2.91 (1.15)

NLR range for inventive composition=1.01 to 2.95

NLR mean (STD) for claimed composition=1.64 (0.65)

NLR for YCW vs inventive composition t-test: p-value 0.06 (significant difference at p<0.10 level).

This result indicates that the inventive composition has a larger impact on the NLR than YCW alone. This result was unexpected and illustrates proved the synergistic effect among the components of the inventive composition.

Further comparison was made between the impact of the inventive composition on intestinal microorganisms, as compared to its key ingredients, (1) inactivated whole cells and lysed cells of Saccharomyces cerevisiae, including cell wall products from lysed cells of Saccharomyces cerevisiae; and (2) Montmorillonite clay.

The intestinal microorganism populations were measured using 16S microbial profiling to identify and classify the relative proportion of bacterial/fungal species. The assessor was blinded to the identity of the supplement. Post-analysis results were decoded. Samples A were derived from dogs fed the YCW supplement, while samples B were obtained from dogs fed the claimed composition supplement.

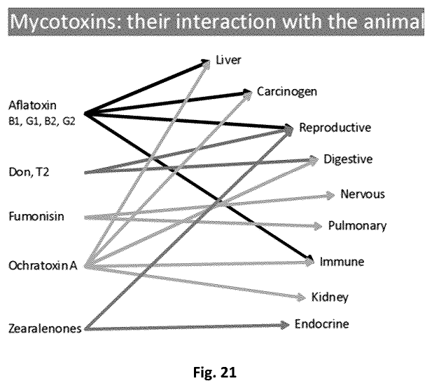

Microbial composition before and after supplementation with A or B (post) compared with a standard diet (initial) are shown in FIG. 21.

At the phylum-level profile of the intestinal microorganisms (microbiome), similar to that published in the literature, the main phyla were:
Firmicutes
Fusobacteria
Bacteroidetes
Proteobacteria
Actinobacteria

The top three phyla mentioned above dominate the core microbiome of healthy dogs. In addition, these dogs had a significant population of Actinobacteria that have been shown to support the immune system by helping maintain a balanced intestinal environment.

YCW alone slightly reduced the Actinobacteria population from 5.0% to 4.7% of the total population. In contrast, the inventive composition doubled the Actinobacteria population from 5.3% to 10.4% of the total population.

In humans, Firmicutes (F) have been associated with adverse health outcomes, e.g., obesity and Bacteroidetes (B) are associated with healthy individuals. Therefore, for humans, the lower the F/B ratio, the healthier the individual is deemed to be. In the study, YCW alone reduced the F/B from 833 down to 58 post-interventions. In comparison, the initial low F/B (15) for the inventive composition arm was maintained by the inventive composition.

The high level of animal protein in dog food results in a high Firmicute population and is present in healthy dogs. Indeed, this phylum dominated the microbiome, and both supplements affected a reduction in this phyla's size. However, the inventive composition was more effective at reducing the proportion, effecting a 2.8 percentage point decrease compared with a 1.4 percentage point decrease for YCW alone.

Fusobacteria is a strict anaerobe and contains agents of severe disease (in humans). Supplementation affected this phylum, with the result that YCW alone produced a 161% increase in the population, whereas the inventive composition reduced the phylum population size by 24.6%

The Proteobacteria are oxygen users and essential for creating a low oxygen environment of anaerobic microbial species associated with healthy intestinal function. While both supplements increased the phyla, the inventive claimed composition's effect was dramatic compared to that induced by YCW: YCW alone induced an increase of 12.2%, whereas the inventive composition induced an increase of 1,458%.

It is a known fact to the person skilled in the art that Montmorillonite clay is not a prebiotic and has no direct effect on the microbiome. Montmorillonite clay has been explored for catalytic activity in the synthesis of complex organic molecules when understanding the origin of life (Joshi et al. Orig Life Evol Biosph. 2007 February, 37(1):3-26. doi: 10.1007/s11084-006-9013-x. Epub 2006 Dec. 8). This indicates that clay promotes the synthesis of complex organic molecules and has no impact on the microbial population of an animal's digestive tract.

It is clear from the above that the impact of the claimed composition on the intestinal microbial population was overall larger, producing a more diverse population and an environment that would promote a healthier intestinal tract, as compared to the individual components. It shows that the components of the claimed composition work in harmony and overall have a synergistic effect.

That it is clear from the above that when each of the individual ingredients was consumed alone, it would only have a limited impact on the animal. However, results from the laboratory and in-home placement tests have shown that the combination of these ingredients in the ratios provided has an apparently synergistic effect, as the combination as disclosed herein has an impact on the effectiveness of the whole diet that is greater than a simple additive effect of that component alone.

It will be appreciated by those skilled in the art that the above described embodiment is merely one example of how the inventive concept can be implemented. It will be understood that other embodiments may be conceived that, while differing in their detail, nevertheless fall within the same inventive concept and represent the same invention.

1. A pet food additive for modifying the rate of progression of food products through the gut of a canine, said pet food additive comprising:
cell wall fragments from lysed or partially lysed cells of Saccharomyces cerevisiae, wherein the cell wall food products include Mannans, Beta-glucans and B-group vitamins;
Montmorillonite clay;
prebiotic material selected from the group consisting of: inulin;
glucose oligosaccharides derived from corn-starch;
psyllium fibre;
xanthan gum and maltodextrin;
soluble fibres;
insoluble fibres;
vegetable starches;
glucose;
di-calcium phosphate;
Vitamin C; and
wherein the mass ratio of fragments from lysed or partially lysed cells of Saccharomyces cerevisiae to Montmorillonite clay is in the range of 6:1 to 4:1;
and wherein a dry mass ratio of said fragments from lysed or partially lysed cells of Saccharomyces cerevisiae to prebiotic materials is in the range of 20:1 to 4:1.

2. The pet food additive of claim 1, wherein said cell wall fragments have a protein content of 40% or greater.

3. The pet food additive of claim 1, wherein said Saccharomyces cerevisiae culture was grown under aerobic conditions.

4. A method of modifying the rate of progression of food products through the gut of a canine, said method comprising the step of administering to said canine a pet food additive according to claim 1.

5. A method of modifying the viscosity of food products as they pass through the gut of a canine, including the step of administering to said canine a pet food additive according to claim 1.

6. A method of mitigating adverse reactions to allergenic components, dietary toxins and foodborne pathogenic bacteria in a canine, including the step of administering to said canine a pet food additive according to claim 1.
